(19) United States
(12) Patent Application Publication
(10) Pub. No.: US 2026/0204542 A1
(43) Pub. Date: Jul. 16, 2026

(54) Free-Standing Biomass-Derived Hybrid Carbon Electrodes

(71) Applicant: Danmarks Tekniske Universitet, Kongens Lyngby (DK)

(72) Inventors: Anjali Achazhiyath Edathil, Kongens Lyngby (DK); Babak Rezaei, Kongens Lyngby (DK); Stephan Sylvest Keller, Kongens Lyngby (DK); Kristoffer Almdal, Kongens Lyngby (DK)

(21) Appl. No.: 19/135,427

(22) PCT Filed: Dec. 8, 2023
(86) PCT No.: PCT/EP2023/084923

§ 371 Date: Jun. 4, 2025

(30) Foreign Application Priority Data
Dec. 9, 2022 (EP) 22212571.8

(51) Int. Cl. H01M 4/1393; H01G 11/24; H01G 11/34; H01G 11/36; H01G 11/44; H01M 4/02; H01M 4/133

(52) U.S. Cl. CPC H01M 4/1393; H01G 11/24; H01G 11/34; H01G 11/36; H01G 11/44; H01M 4/133; H01M 2004/021; H01M 2004/023

(57) ABSTRACT

The present invention relates to a method for manufacturing of free-standing carbon electrodes comprising a patterned three-dimensional structure which was filled with a biomass-derived polymer. 5

### TECHNICAL FIELD

The present invention relates to a method for manufacturing of free-standing hybrid carbon electrodes comprising a patterned three-dimensional structure filled with a biomass-derived polymer.

### BACKGROUND

A highly coveted goal to increase our ability to exploit intermittent renewal energy sources is the development of high-performance electrochemical energy storage (EES) devices. EES devices operate by the shuttling and storage of freely moving ions back and forth between two electrodes in an electrolyte, coupled with the flow of charge carriers via an external circuit.

The electrodes play the most crucial role in the development of EES devices, with the structural properties of the electrode material, including morphology, porosity, volume fraction, thickness, and electrode configuration, affecting the energy density, power density and cycle lifetime of EES devices. Porous carbon-based electrodes are highly promising for EES devices. However, due to challenges associated with their assembly, they are usually obtained in particulate form. This causes severe limitations in controlling the electrode geometry and architecture to achieve desired connectivity and sufficient mechanical strength, resulting in obstacles for practical applications and limitations regarding efficiency.

Carbon electrodes can be prepared from different sources. Carbon derived from renewable sources, such as biomass, is highly coveted for the development of these electrodes. However, the use of biomass-derived precursor materials to produce carbon electrodes is highly challenging as the produced carbon materials are inherently weak and mechanically unstable.

Consequently, in most commercial EES devices such as supercapacitors and batteries, these materials have primarily been utilized as thin films cast on a metallic current collector from a slurry containing the active carbon materials, a conductive agent such as carbon black, a binder and a solvent to dissolve the binder. The main limitations of slurry-based electrodes are that they make use of a current collector (e.g. nickel foam or metal foils) to support the active material, which may limit the loaded amount of electroactive materials and often require multiple processing steps such as coating, drying, calendaring and punching. Furthermore, there are limitations in the electrode geometries or dimensions, which restrict the overall performance of the devices [Z. Liu, X. Yuan, S. Zhang, J. Wang, Q. Huang, N. Yu, Y. Zhu, L. Fu, F. Wang, Y. Chen, Y. Wu, NPGAsia Mater. 2019, 11]. For example, it is challenging to fabricate 3D and very thick electrodes using the traditional slurry-casting method. The sluggish electrode kinetics can lead to limited energy and power density enhancement due to poor utilization of active materials. More importantly, the electrochemically inert materials such as binders and conductive agents used to prepare the electrodes can cause unwanted side reactions during the electrochemical process, resulting in poor performance and challenging reuse and recycling. Furthermore, multi-scale dynamics within the stochastic structure of slurry-based electrodes can limit understanding of the storage mechanisms, hindering their development.

In light of the above, production of advanced carbon electrode architectures with low tortuosity, free-standing configuration and good mechanical strength, that perform with adequate and robust electrochemical properties is a highly desirable and unmet goal in the field of EES in particular if these could be partially derived from biomass.

### SUMMARY

The present invention addresses the above mentioned problems and limitations of carbon electrodes by providing a novel method for the fabrication of free-standing carbon electrodes combining 3D printing and biomass-derived polymers without the use of binders, additional conductive agents or additional metallic current collectors.

In one aspect, the present disclosure provides for a method of producing a free-standing biomass-derived carbon electrode comprising:
a. providing an architectured polymeric template with a patterned three-dimensional open structure, wherein said architectured polymeric template has a designed macrostructural and/or microstructural architecture,
b. filling the template with a biomass-derived polymeric hydrogel,
c. converting the biomass-derived polymeric hydrogel into an aerogel, and
d. pyrolysing the aerogel-filled polymeric template to form a free-standing 3D carbon hybrid electrode.

In preparation of carbon electrodes, biomass-derived carbon does not have good mechanical properties and is normally obtained in powder form. Thus, this invention portrays a method of making mechanically robust free-standing 3D architected biomass-derived electrodes of any shape and size. Moreover, the inventors have demonstrated the preparation of free-standing biomass-derived carbon electrodes with high mechanical strength without the aid of binders, conductive agents or additional metallic current collectors.

Utilizing these free-standing carbon hybrid electrodes, the inventors have demonstrated for the first time, as good performance for supercapacitors and Lithium-ion batteries as for other carbon materials obtained from non biomass-derived sources without the use of binders or other additional components or additional metallic current collectors.

The inventors have found that the biomass-derived carbon is still accessible after integration in the 3D printed scaffold and that the manufactured carbon electrode has satisfactory mechanical stability.

The inventors have found that the scaffold and the biomass-derived polymer form a monolithic carbon structure during pyrolysis i.e. they do not separate.

In another aspect, the present disclosure provides for a free-standing hydrogel-filled architectured polymeric template, comprising
an architectured polymeric template with a patterned three-dimensional open structure, wherein said architectured polymeric template has a designed macrostructural and/or microstructural architecture, and
a hydrogel comprising or consisting of a biomass-derived polymer.

In another aspect, the present disclosure provides for a biomass-derived free-standing 3D carbon hybrid electrode comprising:
a pyrolyzed architectured polymeric template, wherein said architectured polymeric template has a de-signed macrostructural and/or microstructural architecture, and
a pyrolyzed biomass-derived polymeric aerogel,
wherein the pyrolyzed architectured polymeric template and the pyrolyzed biomass-derived polymeric aerogel are interconnected
thereby forming a biomass-derived free-standing 3D carbon hybrid electrode comprising a pyrolyzed hy-drogel-filled architectured polymeric template.

In another aspect, the present disclosure provides for a battery comprising a biomass-derived free-standing 3D carbon hybrid electrode according to the present disclosure.

In another aspect, the present disclosure provides for a supercapacitor comprising a biomass-derived free-standing 3D carbon hybrid electrode according to the present disclosure.

In another aspect, the present disclosure provides for a fuel cell comprising a biomass-derived free-standing 3D carbon hybrid electrode according to the present disclosure.

In a final aspect, the present disclosure provides for the use of a biomass-derived free-standing 3D carbon hybrid electrode according to the present disclosure for energy storage, energy conversion, electrocatalysis, water and wastewater treatment, and/or CO₂ capture.

### DESCRIPTION OF DRAWINGS

FIG. 1. SEM images of multi-scale hierarchical porous structure of a representative alginate-based biomass-derived carbon aerogel hybrid (BCAH) electrode with spider-web design. (a) Top view showing the 4icroporous microlattice of AlginateBCAH (scale: 200 μm), (b) cross-sectional view of the continuous well-integrated porous structure (scale: 200 μm) and (c)-(d) high-resolution images obtained at a different magnification of 4K and 100K, respectively. Scale: 10 μm in (c) and 100 μm in (d). The arrows in (b) indicate the direction of the carbon microlattice structures.

FIG. 2. A) cyclic voltammogram (CV) of different polysaccharide-based BCAH electrodes at a scan rate of 5 mV s⁻¹ in 2 M KCl and B) its corresponding galvanostatic charge-discharge (GCD) curves at a current density of 0.5 mA cm⁻².

FIG. 3. Raman spectra of different polysaccharide-based BCAH electrodes, confirming the presence of graphitic domains in the BCAH electrodes of the present disclosure.

FIG. 4. (a) CV and (b) GCD of Alginate-BCAH electrode in different electrolytes at a scan rate of 5 mV s⁻¹ and current density of 0.5 mA cm⁻², respectively.

FIG. 5. Capacitance retention upon successive charge-discharge cycles for Alginate-BCAH electrodes. First and last ten charge-discharge cycles of a total of 3000 cycles are displayed in the inset.

FIG. 6. A) (i-iii) Top-view SEM image of the 3D architected multi-scale hierarchical porous structured in-situ mineralized alginate-derived carbon aerogel hybrid (iMACAH) electrode showing the spider-web designed carbon microlattice with embedded alginate derived carbon aerogel after mineral etching; High-magnification SEM cross-section images of the pore walls of (iv) iMACAH, (v) Alginate-derived carbon aerogel hybrids (ACAH) and (vi) ACAH etched in KOH (ACAH-(KOH)), scale is: 100 μm in i), 50 μm in ii), 20 μm in iii) and 200 μm in iv-vi); B) Raman and C) N₂ adsorption-desorption isotherms of as-prepared ACAH electrodes.

FIG. 7. A) CV of the as-fabricated ACAH, ACAH (KOH) and iMACAH electrodes at 5 mV s⁻¹. B) GCD curves of the as-fabricated ACAH, ACAH (KOH) and iMACAH electrodes obtained at 0.5 mA cm⁻².

FIG. 8. A) CV at 5 mV s⁻¹ for iMACAH electrodes prepared with alginate of different viscosities. B) CV at 5 mV s⁻¹ for iMACAH electrodes prepared with different wt % of alginate and C) GCD at 0.5 mA cm⁻² for iMACAH electrodes prepared with different wt % of alginate

FIG. 9. Electrochemical properties of iMACAH electrodes. A) CV at different scan rates, B) GCD at different current densities, C) Long-term cycling stability test at a current density of 10 mA cm⁻². Inset of C) displays the first and last 10 charge-discharge cycles.

FIG. 10. Comparison of the ACAH, ACAH (KOH) and iMACAH with Graphene and Resorcinol formaldehyde based CAH electrodes (G-CAH and RF-CAH, respectively). A) CV at scan rate of 5 mV s⁻¹ and B) GCD at a current density of 0.5 mA/cm².

FIG. 11. Electrochemical properties of iMACAH electrodes prepared with different numbers of structural levels obtained by repeating the unit level of the microlattice pattern. A) CV at scan rate of 5 mV s⁻¹, and B) GCD at a current density of 0.5 mA cm-C) Schematic depiction of the iMACAH electrodes prepared with different numbers of structural levels. D) Pictures of iMACAH electrodes with different numbers of structural levels supporting a weight of 100 g.

FIG. 12. Schematic representation of one embodiment of the method to produce electrodes according to the present disclosure.

FIG. 13. Results of a coin cell comprising a biomass-derived free-standing 3D carbon hybrid electrode as one of its electrodes through 5 cycles: A) shows the specific capacity and B) shows the Coulombic efficiency (ratio of the discharge capacity/charge capacity).

FIG. 14. SEM images of a-b representative biopolymer embedded microlattice (BEM), which is an example of a free-standing hydrogel-filled architectured polymeric template, comprising a hydrogel made of a biomass-derived polymer, fabricated using alginate biopolymer at 75× and 150× magnification, c Surface of 3D printed microlattice wall (500× magnification) and embedded d alginate, e pectin, f gelzan, g chitosan, h agarose, and i cellulose aerogels at 1500× magnification.

### DEFINITIONS

The terms “rationally designed” or “architectured” as used herein in relation to a polymeric template” refer to a template that has been designed, usually computer-designed, to have a specific, designed macrostructural and/or microstructural architecture. “Architecture” refers to the dimensions, shape and specific patterns of the template. The architecture of an architectured or rationally designed 3D template can be for example, designed using a software, such as Computer-Aided design (CAD) software and fabricated using 3D printing technologies. When a template is rationally designed, the actual architecture of the template closely matches the one of the design.

In contrast, a polymeric template that is not rationally designed has a macrostructural and/or microstructural architecture that is stochastically generated producing arbitrary shape, dimensions and patterns depending on the method of production and cannot be controlled.

As used herein “pattern” refers to the placement of individual features relative to each another. For example, the placement of individual holes or empty spaces in a polymeric template relative to each other. As used herein, a pattern may be a regular pattern in one or more directions if the individual features are placed regularly in said direction. The holes or empty spaces can be surrounded by any structure or building unit having a macroscopic and/or microscopic architecture forming a geometric shape or design.

As used herein “macroscopic” in relation to the template size, refers to sizes, shapes, patterns or dimensions in the scale of tenths of milimeters (0.1 mm) to tens of centimeters (10 cm) or even hundreds of centimeters or more (100 cm). As used herein “microscopic” refers to sizes, shapes, patterns or dimensions in the scale of tenths of microns (0.1 μm) to tenths of milimeters (0.1 mm).

As used herein the term “hybrid” when referred to carbon refers to carbon that is obtained from different precursor materials. The carbon electrodes disclosed herein contain carbon originating from the polymeric template and carbon originating from the biomass-derived polymer. In the resulting structure after pyrolysis, the carbon formed from the polymeric template and the carbon formed from the biomass-derived polymer are integrated into one structure. The hybrid carbon may comprise covalent carbon-carbon bonds between the pyrolytic carbon from the biomass-derived polymer and the pyrolytic carbon from the polymeric template.

A “pore” as used herein refers to an opening in a surface. “Macropores” as used herein refer to pores or cavities having a width exceeding about 50 nm. “Micropores” as used herein refer to pores or cavities having a width not exceeding about 2.0 nm. “Mesopores” are pores of an intermediate size having a width between about 2.0 nm to 50 nm.

A “high temperature resin” as used herein refers to photocrosslinkable polymers with good thermal stability that are able to maintain the shape during the initial heating stages of the pyrolysis process without thermal decomposition. High temperature resins and their precursors can be acquired from different suppliers, such as Formlabs high-temperature resin (HTR) or Boston Micro Fabrication (BMF) high-temperature yellow resin (HTY20), as well as others which are well-known to the person of skill in the art.

As used herein the term “pyrolyzable” or “precursor” referring to a material or polymer refers to polymers or materials that decompose in the presence of heat under an inert atmosphere (e.g. nitrogen, argon, forming gas) and molecularly rearrange to produce carbon.

As used herein “photopolymer” refers to a composition that undergoes polymerization, cross-linking and/or any other curing or hardening reaction in response to actinic radiation. “Photopolymer” refers as well to the composition resulting from said polymerization, cross-linking or any other curing or hardening reaction in response to actinic radiation. “Actinic radiation” is used herein to refer to radiation that is able to produce chemical changes caused by radiation. Actinic radiation may for example be ultra-violet, visible or infra-red radiation. In particular, Actinic radiation is referred to radiation that can promote or initate photopolymerization processes. Photopolymers comprise monomers with active groups, such as acrylate or methacrylate groups, epoxy groups, vinyl groups, styrenic groups and/or derivatives and analogs thereof allowing for crosslinking of the monomers upon radiation induced activation. Photopolymer compositions may also comprise photoinitiators that initiate polymerization, cross-linking or hardening reactions upon irradiation. For example, type 1 photopolymers undergo photoinitiated radical, cationic or anionic chain polymerization on irradiation to yield cross-linked polymer networks.

As used herein “gel” refers to a non-fluid colloidal network or polymer network that is expanded throughout its whole volume by a fluid. For example, a gel may be a hydrogel. The term “hydrogel” refers to a gel wherein the swelling agent is water. An “alcohogel” is use to refer to a gel or a hydrogel wherein the swelling fluid, such as water is replaced with a solvent, such as any alcohol. An “aerogel” is use to refer to a gel or a hydrogel or an alcohogel wherein the swelling fluid, such as water or an alcohol, has been removed, for example by any of the drying techniques such as supercritical, ambient, sub-critical and/or freeze-drying.

A “binder” as used herein refers to additional non-active materials used to hold electrode materials in place and provide sufficient mechanical strength.

As used herein, “additional metallic current collector” refers to a metallic conductive material that has good mechanical strength which is used as a support for carbon electrodes in order to provide for the necessary shape and/or mechanical strength and for electrical connection to an external setup.

As used herein, the term “free-standing” refers to self-standing, binder-free (without using binders) and not supported by additional metallic current collectors.

### DETAILED DESCRIPTION

### Method of Producing an Electrode

One aspect of the present disclosure is to provide a method of producing a free-standing biomass-derived carbon hybrid electrode comprising:
a. providing a rationally designed polymeric template with a patterned three-dimensional open structure,
b. filling the template with a biomass-derived polymeric hydrogel,
c. converting the biomass-derived polymeric hydrogel into an aerogel, and
d. pyrolyzing the aerogel-filled template to form a free-standing 3D carbon hybrid electrode.

One aspect of the present disclosure is to provide a method of producing a free-standing biomass-derived carbon hybrid electrode comprising:
a. providing an architectured polymeric template with a patterned three-dimensional open structure, wherein said architectured polymeric template has a designed macrostructural and/or microstructural architecture,
b. filling the template with a biomass-derived polymeric hydrogel,
c. converting the biomass-derived polymeric hydrogel into an aerogel, and
d. pyrolysing the aerogel-filled template to form a free-standing 3D carbon hybrid electrode.

An architectured polymeric template is one that has been designed to have a specific macrostructural and/or microstructural pattern defined by the placement of individual holes or empty spaces relative to each other. The architecture, or placement of individual holes or empty spaces at pre-determined distances or positions relative to each other, of a rationally designed 3D template can be, for example, designed using a software, such as Computer-Aided design (CAD) software and fabricated using 3D printing technologies.

When a template is rationally designed (or architectured), the actual architecture of the template closely matches the one of the design. In contrast, a polymeric template that is not architectured (or not rationally designed) has a macrostructural and/or microstructural architecture that is stochastically generated producing arbitrary shape, dimensions and patterns depending on the method of production and cannot be controlled.

In one embodiment, the architectured (or rationally designed) polymeric template has a specific macrostructural and/or microstructural architecture, said architecture having a pattern defined by the placement of individual holes or empty spaces in the polymeric template relative to each other. In one embodiment, the placement of individual holes or empty spaces in the template is at pre-determined distances or positions relative to each other.

In one embodiment, the architectured polymeric template has a specific macrostructural and/or microstructural architecture, said architecture having a pattern defined by the placement of individual holes or empty spaces in the polymeric template, wherein the placement of said individual holes or empty spaces relative to each other is not arbitrary, and/or is not stochastic, and/or is controlled.

In one embodiment, the architectured polymeric template has a specific macroscopic pattern defined by the placement of individual holes or empty spaces relative to each other in the scale of tenths of millimiters (0.1 mm) to tens of centimeters (10 cm) in the polymeric template, wherein the placement of said individual holes or empty spaces relative to one is not arbitrary, and/or is not stochastic, and/or is controlled.

In one embodiment, the architectured polymeric template has a specific microscopic pattern defined by the placement of individual holes or empty spaces relative to each other in the scale of tenths of microns (0.1 μm) to tenths of milimiters (0.1 mm), wherein the placement of said individual holes or empty spaces relative to each other is not arbitrary, and/or is not stochastic, and/or is controlled.

In one embodiment, the architectured polymeric template has:
a. a specific macroscopic pattern defined by the placement of individual holes or empty spaces relative to each other in the scale of tenths of milimiters (0.1 mm) to tens of centimeters (10 cm) in the polymeric template, wherein the placement of said individual holes or empty spaces relative to each other is not arbitrary, and/or is not stochastic, and/or is controlled; and
b. a specific microscopic pattern defined by the placement of individual holes or empty spaces relative to each other in the scale of tenths of microns (0.1 μm) to tenths of milimiters (0.1 mm), wherein the placement of said individual holes or empty spaces relative to each other is not arbitrary, and/or is not stochastic, and/or is controlled.

A rationally designed (or architectured) polymeric template with a patterned three-dimensional open structure may be manufactured by means of additive manufacturing.

Additive manufacturing (AM) or additive layer manufacturing (ALM) is the industrial production name for 3D printing, a computer controlled process that creates three dimensional objects by adding materials layer-by-layer on top of each other.

Thus, a rationally designed (or architectured) polymeric template with a patterned 3D open structure may be manufactured by 3D printing the polymeric template. Such an architectured polymeric template with a patterned three-dimensional open structure is advantageous as it ensures that the resulting electrode will have large surface area and at the same time high mechanical strength. Moreover, the pyrolyzed architectured polymeric template, wherein said architectured polymeric template has a de-signed macrostructural and/or microstructural architecture, functions as current collector because it is more compact and conductive than the porous carbon obtained from the hydrogels (i.e. pyrolyzed biomass-derived polymeric aerogel). Thus, in one embodiment, the architectured polymeric template with a patterned three-dimensional open structure is 3D printed. As it will be known by someone of skill in the art, many systems and polymers are available for 3D printing polymeric templates. For example, stereolithography (SLA) 3D printing, digital light processing (DLP), projection micro stereolithography (PuSLA) or two-photon polymerization (2PP). Other methods for 3D printing templates suitable for the present invention are continuous liquid interface production (CLIP), inkjet printing (IJP), bioprinting, fused filament fabrication (FFF), fused deposition modelling (FDM) or laminated object manufacturing (LOM). The skilled artisan is aware of diverse ways to achieve a polymeric template, for example as described herein.

Architectured polymeric templates according to the present disclosure may also be prepared using other techniques to produce microlattice materials, such as the photopolymer waveguide process described in Jacobsen et al. 2007 (Micro-scale Truss Structures formed from Self-Propagating Photopolymer Waveguides. Advanced Materials 19 (22) 3892-3896), or using inclined UV photolithography as described in Sato et al. 2004 (Three-dimensional micro-structures consisting of high aspect ratio inclined micro-pillars fabricated by simple photolithography. Microsystem Technologies 10, 440-443 (2004)).

In one embodiment, the polymeric template has an open 3D microlattice pattern. The inventors have found that these microlattice structures ensured good structural integrity of the aerogel-filled template after pyrolysis. In one embodiment, the open 3D microlattice pattern is a mesh with vertical and horizontal cylindrical connections. In one embodiment, the open 3D microlattice pattern is a mesh with vertical and horizontal cylindrical connections of about 0.2-0.6 mm diameter and about 0.5-10 mm mesh spacing, such as of about 0.4 mm diameter and about 0.7 mm mesh spacing.

In one embodiment, the polymeric template comprises hollow parts. In one embodiment, the polymeric template has a macroscopic open structure. In one embodiment, the polymeric template has a microscopic structure. In one embodiment, the polymeric template has a macroscopic and a microscopic structure.

The geometric 3D open structure provides the electrode with a larger surface area and facilitates effective circulation of electrolytes.

In one embodiment, the architectured polymeric template comprises a pyrolyzable photopolymer. In one embodiment, the photopolymer is a high temperature resin. High temperature resins have good temperature stability, such resins are suitable as they maintain the shape at high temperatures, such as temperatures that can go up to 183° C. in atmospheric conditions.

In one embodiment, the photopolymer polymerizes when exposed to actinic radiation. In one embodiment, the photopolymer comprises photopolymerizable active groups, such as vinyl, allyl, and/or styrenic groups. In one embodiment, the photopolymer comprises acrylate groups, methacrylate groups, epoxy groups or any combination thereof. In one embodiment, the photopolymer comprises acrylated monomers, methylacrylated monomers, epoxy-based monomers, acrylated oligomers, methacrylated oligomers and/or epoxy-based oligomers or any combinations thereof. In one embodiment, the photopolymer comprises a photoinitiator.

In one embodiment, the architectured polymeric template is a pyrolyzable material. In one embodiment, the architectured polymeric template is subjected to a pre-treatment prior to step b., wherein the pre-treatment increases the hydrophilicity and/or the wettability of the architectured polymeric template. Different methods are available to increase the hydrophilicity and/or wettability of materials. For example, surface coating, plasma treatment, UV-ozone treatment, glow discharge, silanization, macromolecule grafting, chemical processing are used to enhance the hydrophilicity of different kinds of materials. Thus, in one embodiment, the pre-treatment comprises surface coating, plasma treatment, UV-ozone treatment, glow discharge, silanization, macromolecule grafting and/or chemical processing of the architectured polymeric template. By increasing the hydrophilicity of the architectured template, these pre-treatments facilitate easy infiltration and loading of the biomass-derived polymer into the architectured open structure of the polymeric template.

Oxygen or air plasma treatment is a popular and convenient method performed for improving the hydrophilicity and/or wettability of a surface. Thus, in one embodiment, the pre-treatment comprises oxygen or air plasma treatment of the rationally designed polymeric template. This method is used to make the polymeric template more hydrophilic by forming new oxygen-containing groups which will ensure easy flow of the biomass-derived precursor solution into its open structure.

The method according to the present disclosure comprises a step b. of filling the architectured polymeric template with a biomass-derived polymeric hydrogel. In one embodiment, this step comprises filling the hollow parts of the architectured polymeric template with a homogeneous aqueous solution of a biomass-derived polymer. In one embodiment, step b. comprises cross-linking the biomass-derived polymer to form a hydrogel, thereby obtaining a hydrogel-filled architectured polymeric template.

In one embodiment, step b. comprises cross-linking the biomass-derived polymer by gelation by a physical and/or chemical cross-linking to obtain the hydrogel. In one embodiment, the cross-linking is obtained by addition of a cross-linking agent. In one embodiment, the cross-linking of the biomass-derived polymer to form a hydrogel comprises spraying the crosslinking agent and/or immersing the architectured porous polymeric template filled with the biomass-derived polymer in the crosslinking agent. In one embodiment, the architectured polymeric template filled with the biomass-derived polymer is immersed in the crosslinking agent for at least 5 minutes, such as for 5 to 60 minutes, such as for 5 to 30 minutes, such as for 5 to 20 minutes, such as for 5 to 15 minutes, such as for 10 to 20 minutes, such as for about 15 minutes.

In one embodiment, the architectured polymeric template filled with the biomass-derived polymer is immersed in the crosslinking agent for more than 60 minutes, such as for 3 hours or more, such as for 5 hours or more, such as for 12 hours or more, such as for 24 hours or more. In one embodiment, the architectured polymeric template filled with the biomass-derived polymer is immersed in the crosslinking agent overnight.

The crosslinking of the biomass-derived polymers into hydrogels using chemical methods occurs instantaneously when the biomass-derived polymers come into contact with the respective chemical crosslinking agent. However, it is important to continue chemical crosslinking of the so-formed hydrogels for a period for at least 5 minutes to form a biomass-derived hydrogel with sufficient mechanical strength. This is especially important in case of this invention to ensure that the so-formed hydrogels stay within the architectured polymeric template.

According to the present disclosure, any biomass-derived polymer that is able to form a hydrogel, which in turn can be dried to form an aerogel, and pyrolyzed, is suitable to perform the methods described herein. In one embodiment, the biomass-derived polymer is a polysaccharide-based polymer. In one embodiment, the biomass-derived polymer is agarose, cellulose, chitosan, gelzan, pectin, lignin or alginate.

In one embodiment, the homogeneous aqueous solution comprising the biomass-derived polymer also comprises an inorganic compound. In one embodiment, the inorganic compound is a water soluble salt of an ion selected from the group consisting of: calcium ion, permanganate ion, manganese ion, ruthenium ion, nickel ion, tin ion, iridium ion, iron ion, vanadium ion, cobalt ion, molybdenum ion, zinc ion and any combination thereof. Inorganic compounds dissolved in the homogeneous aqueous solution comprising the biomass-derived polymer may be used as precursors for generating a hard template within the hydrogel. For example, via precipitation of salts induced by chemical reaction or by formation of salts when the hydrogel is dried to form an aerogel. The precipitated salts act as a hard template and decompose to form the corresponding oxides upon pyrolysis. These metal oxides can remain in the 3D hybrid electrode potentially acting as a pseudocapacitive energy storage material or they can be removed using mild acid washing, which increases the porosity of the final carbon material post pyrolysis.

In one embodiment, the inorganic compound is a metal oxide nanoparticle of an ion selected from the group consisting of: manganese ion, ruthenium ion, nickel ion, tin ion, 15ridium ion, iron ion, vanadium ion, cobalt ion, molybdenum ion, zinc ion, graphene oxide, graphene or a derivative thereof, carbon nanotube, different transition-metal dichalcogenides or a combination thereof. The inorganic compounds are uniformly dispersed in the homogeneous aqueous solution comprising the biomass-derived polymer, which upon pyrolysis act as a pseudocapacitive energy storage material. In one embodiment the metal oxide is added in step b. In one embodiment, the metal oxide nanoparticle as described herein is formed upon pyrolysis in step d.

In one embodiment, step b. further comprises providing an inorganic compound as defined herein. In one embodiment, step b. further comprises precipitation of the inorganic compound in form of particles within the hydrogel-filled architectured polymeric template. In one embodiment, the inorganic compound particles are calcium hydroxide particles. In one embodiment, the inorganic compound particles are calcium carbonate particles.

In one embodiment, the hydrogel-filled architectured polymeric template is washed with water prior to step c. Step c. is the step of converting the biomass-derived polymeric hydrogel into an aerogel. Hydrogels may be converted into aerogels by drying to remove water. Thus, in one embodiment, step c. comprises drying the hydrogel-filled architectured polymeric template to provide an aerogel-filled architectured polymeric template.

Hydrogels can be converted to aerogels by using different drying techniques such as supercritical CO₂ drying, freeze-drying, ambient drying, microwave drying or a combination of one or more of these techniques. It is also possible to replace the water with alcohol prior to drying, which has an influence on the final porosity and microstructure of the aerogel.

In one embodiment, step c. comprises drying the hydrogel-filled architectured polymeric template using supercritical CO₂ drying, freeze-drying, ambient drying, microwave drying or a combination thereof. In one embodiment, step c. comprises drying the hydrogel-filled architectured polymeric template using freeze-drying. The type of freezing used before freeze-drying may be using dry ice, liquid nitrogen or conventional freezing.

The method according to the present disclosure comprises a step d. of pyrolysing the aerogel-filled template to form a free-standing 3D carbon hybrid electrode. In one embodiment, step d. comprises pyrolyzing the aerogel-filled architectured polymeric template under an inert atmosphere at 700° C. or more, such as at 750° C. or more, such as at 800° C. or more, such as at 850° C. or more, such at 900° C. or more, such as at 950° C. or more, such as at 1000° C. or more, such as at 1100° C., such as at between 900° C. and 1100° C., for at least 10 seconds, such as for at least 1 minute, such as for at least 10 minutes, such as for at least 30 minutes, such as for at least 60 minutes, such for at least 80 minutes, such as for at least 90 minutes, such as for at least 120 minutes, such as for at least 180 minutes, thereby obtaining a biomass-derived carbon electrode. In one embodiment, step d. comprises pyrolyzing the aerogel-filled architectured polymeric template under an inert atmosphere at a temperature of more than 1100° C., such as at 1200° C., 1300° C., 1400° C., 1500° C. or more.

In a preferred embodiment, step d. comprises pyrolyzing the aerogel-filled architectured polymeric template under an inert atmosphere for more than 1 hour at a temperature of about 900° C. to about 1100° C. In one embodiment, step d. comprises pyrolyzing the aerogel-filled architectured polymeric template under an inert atmosphere for 2 hours at a temperature of about 900° C.

In one embodiment, the pyrolyzing occurs under an inert atmosphere, such as a nitrogen atmosphere, an argon atmosphere or in a vacuum. In one embodiment, the pyrolyzing occurs in an oven, a heater, a griller and/or a furnace. In one embodiment, the pyrolyzing occurs in a tube furnace, such as a ceramic tube furnace, a quartz tube furnace or a muffle furnace. A suitable furnace is one that is able to provide the necessary temperature while providing a secured gas flow to produce and maintain the inert atmosphere in the furnace. A suitable furnace is also one that is able to provide the necessary temperature and to keep a vacuum or maintain an inert atmosphere in the furnace.

In one embodiment, step d. comprises:
i. heating the aerogel-filled architectured polymeric template under inert atmosphere at a temperature between 300° C. and 410° C. for at least 1 minute; and
ii. heating the aerogel-filled architectured polymeric template under inert atmosphere at a temperature between 700° C. and 1100° C. for at least 1 minute.

The execution of steps i. and ii. may help to better preserve the geometry of the final electrode and avoid deformations such as bending or twisting caused by the entrapment of gas inside the architectured polymeric template during degassing of photopolymers.

In one embodiment, step i. is performed for at least a minute to a few hours. For example, step i. is performed between a minute and 10 hours, such as between a minute and 5 hours, such as between a minute and 2 hours, such as between a minute and 1 hour. In one embodiment, step ii. is performed for at least a minute to a few hours. For example, step ii. is performed between a minute an 10 hours, such as between a minute and 5 hours, such as between a minute and 2 hours, such as between a minute and 1 hour.

In one embodiment, step d. comprises:
i. heating the aerogel-filled architectured polymeric template under an inert atmosphere at 350° C. to 500° C., such as at 400° C. to 450° C., for 30 minutes to 120 minutes, such as for about 1 hour;
ii. heating the aerogel-filled architectured polymeric template under an inert nitrogen atmosphere at 900° C. to 1100° C. for 30 minutes to 180 minutes, such as for about 2 hours.

In one embodiment, step i. is not needed, for example if a high resolution 3D printing technique is used to fabricate the polymeric template providing sufficiently small structural features to avoid gas entrapment during pyrolysis, and the method disclosed herein only comprises step ii., that is heating directly at a temperature between 700° C. and 1100° C. or more.

In one embodiment, the aerogel-filled architectured polymeric template is heated under an inert nitrogen atmosphere at a temperature above 1100° C. for 30 minutes to 180 minutes, such as for about 2 hours or even longer.

In one embodiment, the method comprises a further step of post-activation of the pyrolyzed free-standing biomass-derived carbon electrode after step d. Post-activation can be achieved by physical of chemical treatments as it will be known to someone of skill in the art. For example, by treatment with CO₂, KOH, H₂SO₄, H₃PO₄, ZnCl₂ The post-activation treatment can be used to increase the surface area of the electrodes.

### a Free-Standing Filled Polymeric Template and Electrode

One aspect of the present disclosure provides for a hydrogel-filled rationally designed polymeric template as described herein. One aspect of the present disclosure provides for an aerogel-filled rationally designed polymeric template as described herein.

One aspect of the present disclosure provides for a free-standing hydrogel-filled architectured polymeric template, comprising:
an architectured polymeric template with a patterned three-dimensional open structure, wherein said architectured polymeric template has a designed macrostructural and/or
microstructural architecture, and
a hydrogel made of a biomass-derived polymer.

In one embodiment, the hydrogel-filled architectured polymeric template comprises:
a architectured polymeric template wherein said template has a specific macrostructural and/or microstructural architecture, said architecture having a pattern defined by the placement of individual holes or empty spaces in the polymeric template relative to each other, and
a hydrogel filling the template.

In one embodiment, the aerogel-filled architectured polymeric template comprises: a architectured polymeric template wherein said template has a specific macrostructural and/or microstructural architecture, said architecture having a pattern defined by the placement of individual holes or empty spaces in the polymeric template relative to each other, and
an aerogel filling the template.

In one embodiment, the hydrogel-filled architectured polymeric template comprises: a architectured polymeric template wherein said template has a specific macrostructural and/or microstructural architecture, said architecture having a pattern defined by the placement of individual holes or empty spaces in the polymeric template, wherein the placement of said individual holes or empty spaces relative to each other is not arbitrary, and/or is not stochastic, and/or is controlled, and
a hydrogel filling the template.

In one embodiment, the aerogel-filled architectured polymeric template comprises: a architectured polymeric template wherein said template has a specific macrostructural and/or microstructural architecture, said architecture having a pattern defined by the placement of individual holes or empty spaces in the polymeric template, wherein the placement of said individual holes or empty spaces relative to each other is not arbitrary, and/or is not stochastic, and/or is controlled, and
an aerogel filling the template.

In one embodiment, the filled architectured polymeric template comprises:
a architectured polymeric template wherein said template has a specific macroscopic pattern defined by the placement of individual holes or empty spaces relative to each other in the scale of tenths of milimiters (0.1 mm) to tens of centimeters (10 cm) in the polymeric template, wherein the placement of said individual holes or empty spaces relative to each other is not arbitrary, and/or is not stochastic, and/or is controlled, and
a hydrogel or an aerogel filling the template.

In one embodiment, the filled architectured polymeric template comprises:
a architectured polymeric template wherein said template has a specific microscopic pattern defined by the placement of individual holes or empty spaces relative to each other n the scale of tenths of microns (0.1 μm) to tenths of milimiters (0.1 mm) the polymeric template, wherein the placement of said individual holes or empty spaces relative to each other is not arbitrary, and/or is not stochastic, and/or is controlled, and
a hydrogel or an aerogel filling the template.

In one embodiment, the filled architectured polymeric template comprises:
a architectured polymeric template wherein said template has:
   a. a specific macroscopic pattern defined by the placement of individual holes or empty spaces having dimensions in the scale of tenths of milimiters (0.1 mm) to tens of centimeters (10 cm) in the polymeric template, wherein the placement of said individual holes or empty spaces relative to each other is not arbitrary, and/or is not stochastic, and/or is controlled; and
   b. a specific microscopic pattern defined by the placement of individual holes or empty spaces having dimensions in the scale of tenths of microns (0.1 μm) to tenths of milimiters (0.1 mm) the polymeric template, wherein the placement of said individual holes or empty spaces relative to each other is not arbitrary, and/or is not stochastic, and/or is controlled; and
a hydrogel or an aerogel filling the template.

In one embodiment, the hydrogel-filled architectured polymeric template comprises:
i. a hydrogel part or an aerogel part; and
ii. an architectured polymeric template part, wherein said architectured part has a designed macrostructural and/or microstructural architecture said architecture having a pattern defined by the placement of individual holes or empty spaces in the polymeric template, wherein the placement of said individual holes or empty spaces relative to each other is not arbitrary, and/or is not stochastic, and/or is controlled.

In one embodiment, the aerogel-filled architectured polymeric template comprises:
i. an aerogel part having an interconnected 3D hierarchical porous network of stochastically distributed macro-, meso-, and micro-pores; and
ii. an architectured polymeric template part, wherein said template has a designed macroscopic pattern defined by the placement of individual holes or empty spaces having physical dimensions in the scale of tenths of milimiters (0.1 mm) to tens of centimeters (10 cm) in the polymeric template, wherein the placement of said individual holes or empty spaces relative to each other is not arbitrary, and/or is not stochastic, and/or is controlled.

In one embodiment, the aerogel-filled architectured polymeric template comprises:
i. an aerogel part having an interconnected 3D hierarchical porous network of stochastically distributed macro-, meso-, and micro-pores; and
ii. an architectured polymeric template part, wherein said template has a designed microscopic pattern defined by the placement of individual holes or empty spaces having physical dimensions in the scale of tenths of microns (0.1 μm) to tenths of milimiters (0.1 mm) the polymeric template, wherein the placement of said individual holes or empty spaces relative to eac other is not arbitrary, and/or is not stochastic, and/or is controlled.

One aspect of the present disclosure provides for a biomass-derived free-standing 3D carbon hybrid electrode comprising a pyrolyzed aerogel-filled architectured polymeric template.

For example, the electrode comprises an aerogel-filled architectured polymeric template that has been pyrolzyed.

One aspect of the present disclosure provides for a biomass-derived free-standing 3D carbon hybrid electrode comprising:
a pyrolyzed architectured polymeric template, wherein said architectured polymeric template has a de-signed macrostructural and/or microstructural architecture, and
a pyrolyzed biomass-derived polymeric aerogel,
wherein the pyrolyzed architectured polymeric template and the pyrolyzed biomass-derived polymeric aerogel are interconnected
thereby forming a biomass-derived free-standing 3D carbon hybrid electrode comprising a pyrolyzed hy-drogel-filled architectured polymeric template.

In one embodiment, the architectured or architectured polymeric template, the hydrogel, the aerogel, the biomass-derived polymer and the pyrolysis are as described elsewhere herein.

In one embodiment, the biomass-derived free-standing 3D carbon hybrid electrode comprises an architectured designed polymeric template wherein said template has a designed macrostructural and/or microstructural architecture, said architecture having a pattern defined by the placement of individual holes or empty spaces in the polymeric template relative to each other. In one embodiment, the placement of individual holes or empty spaces in the template is at pre-determined distances or positions relative to each other.

In one embodiment, the biomass-derived free-standing 3D carbon hybrid electrode comprises an architectured designed polymeric template, wherein said template has a designed macrostructural and/or microstructural architecture, said architecture having a pattern defined by the placement of individual holes or empty spaces in the polymeric template, wherein the placement of said individual holes or empty spaces relative to each other is not arbitrary, and/or is not stochastic, and/or is controlled.

In one embodiment, the biomass-derived free-standing 3D carbon hybrid electrode comprises a pyrolyzed architectured polymeric template wherein said template has a designed macroscopic pattern defined by the placement of individual holes or empty spaces having physical dimensions in the scale of tenths of milimiters (0.1 mm) to tens of centimeters (10 cm) in the polymeric template, wherein the placement of said individual holes or empty spaces relative to each other is not arbitrary, and/or is not stochastic, and/or is controlled.

In one embodiment, the biomass-derived free-standing 3D carbon hybrid electrode comprises a pyrolyzed architectured polymeric template wherein said template has a specific microscopic pattern defined by the placement of individual holes or empty spaces having physical dimensions in the scale of tenths of microns (0.1 μm) to tenths of milimiters (0.1 mm) the polymeric template, wherein the placement of said individual holes or empty spaces relative to each other is not arbitrary, and/or is not stochastic, and/or is controlled.

In one embodiment, the biomass-derived free-standing 3D carbon hybrid electrode comprises a pyrolyzed architectured polymeric template wherein said template has:
a. a designed macroscopic pattern defined by the placement of individual holes or empty spaces having physical dimensions in the scale of tenths of milimiters (0.1 mm) to tens of centimeters (10 cm) in the polymeric template, wherein the placement of said individual holes or empty spaces relative to each other is not arbitrary, and/or is not stochastic, and/or is controlled; and
b. a specific microscopic pattern defined by the placement of individual holes or empty spaces having physical dimensions in the scale of tenths of microns (0.1 μm) to tenths of milimiters (0.1 mm) the polymeric template, wherein the placement of said individual holes or empty spaces relative to each other is not arbitrary, and/or is not stochastic, and/or is controlled.

In one embodiment, the biomass-derived free-standing 3D carbon hybrid electrode has an interconnected 3D hierarchical porous network structure consisting of macro-, meso- and micro-pores.

In one embodiment, the biomass-derived free standing 3D carbon hybrid electrode has a monolithic structure, such as wherein the pyrolyzed aerogel-filled architectured polymeric template comprises carbon-carbon covalent bonds linking the pyrolzed architectured polymeric template and the pyrolyzed aerogel.

A unique feature of the electrodes of the present disclosure is that they have a monolithic structure and at the same time keep a distinction between two materials at microscopic level, as it can be seen in the SEM figures, having different densities.

In one embodiment, the pyrolyzed architectured polymeric template in the biomass-derived free-standing 3D carbon hybrid electrode of the present disclosure has a higher density than the pyrolized biomass-derived polymeric aerogel.

In one embodiment, the biomass-derived free-standing 3D carbon hybrid electrode comprises:
i. a pyrolyzed aerogel part; and
ii. a pyrolzed architectured polymeric template part, wherein said template has a specific macrostructural and/or microstructural architecture, said architecture having a pattern defined by the placement of individual holes or empty spaces in the polymeric template, wherein the placement of said individual holes or empty spaces relative to each other is not arbitrary, and/or is not stochastic, and/or is controlled.

In one embodiment, the biomass-derived free-standing 3D carbon hybrid electrode comprises:
i. a pyrolyzed aerogel part having an interconnected 3D hierarchical porous network of stochastically distributed macro-, meso-, and micro-pores; and
ii. a pyrolzed architectured polymeric template part, wherein said template has a specific macrostructural and/or microstructural architecture, said architecture having a pattern defined by the placement of individual holes or empty spaces in the polymeric template, wherein the placement of said individual holes or empty spaces relative to each other is not arbitrary, and/or is not stochastic, and/or is controlled.

In one embodiment, the biomass-derived free-standing 3D carbon hybrid electrode comprises:
i. a pyrolyzed aerogel part having an interconnected 3D hierarchical porous network of stochastically distributed macro-, meso-, and micro-pores; and

ii. a pyrolzed architectured polymeric template part, wherein said template has a specific macroscopic pattern defined by the placement of individual holes or empty spaces having dimensions in the scale of tenths of milimiters (0.1 mm) to tens of centimeters (10 cm) in the polymeric template, wherein the placement of said individual holes or empty spaces relative to each other is not arbitrary, and/or is not stochastic, and/or is controlled.

In one embodiment, the biomass-derived free-standing 3D carbon hybrid electrode comprises:
i. a pyrolyzed aerogel part having an interconnected 3D hierarchical porous network of stochastically distributed macro-, meso-, and micro-pores; and
ii. a pyrolzed architectured polymeric template part, wherein said template has a designed microscopic pattern defined by the placement of individual holes or empty spaces having dimensions in the scale of tenths of microns (0.1 μm) to tenths of milimiters (0.1 mm) the polymeric template, wherein the placement of said individual holes or empty spaces relative to each other is not arbitrary, and/or is not stochastic, and/or is controlled.

In one embodiment, the pyrolyzed aerogel part and the pyrolyzed architectured polymeric template part are linked by carbon-carbon covalent bonds.

The combination of a pyrolyzed biomass-derived aerogel region and a pyrolyzed architectured polymeric template as described herein provides for improved mechanical, electrical and electrochemical properties.

In one embodiment, the biomass-derived free standing 3D carbon hybrid electrode has a thickness of 100 μm to 15 mm, such as a thickness of between about 200 μm and about 400 μm, such as between about 400 μm and about 600 μm, such as between about 600 μm and about 800 μm, such as between about 800 μm and about 1 mm, such as between about 1.0 mm and about 1.2 mm, such as between about 1.2 mm and 1.4 mm, such as between about 1.4 mm and about 1.6 mm, such as between about 1.6 mm and 2.0 mm, such as about between 2.0 mm and about 2.5 mm, such as a thickness of about 3 mm, such as a thickness of about 4 mm, such as a thickness of about 5 mm, such as a thickness of about 10 mm.

In one embodiment, the biomass-derived free standing 3D carbon hybrid electrode has a total pore volume of 0.01 to 10 cm³/g, such as of about 0.01 cm³/g, such as of about 0.05 cm³/g, such as of about 0.1 cm³/g, such as of about 0.2 cm³/g, such as of about 0.3 cm³/g, such as of about 0.5 cm³/g, such as of about 0.7 cm³/g, such as of about 1.0 cm³/g, such as of about 2.0 cm³/g, such as of about 3.0 cm³/g, such as of about 4.0 cm³/g, such as of about 5.0 cm³/g, such as of about 6.0 cm³/g, such as of about 7.0 cm³/g, such as of about 9.0 cm³/g, such as of about 10.0 cm³/g.

In one embodiment, the biomass-derived free standing 3D carbon hybrid electrode has a micropore volume of 0.01 to 3 cm³/g, such as of about 0.01 cm³/g, such as of about 0.02 cm³/g, such as of about 0.03 cm³/g, such as of about 0.04 cm³/g, such as of about 0.05 cm³/g, such as of about 0.06 cm³/g, such as of about 0.1 cm³/g, such as of about 0.2 cm³/g, such as of about 0.4 cm³/g, such as of about 0.6 cm³/g, such as of about 0.8 cm³/g, such as of about 1.0 cm³/g, such as of about 1.5 cm³/g, such as of about 2.0 cm³/g, such as of about 2.5 cm³/g, such as of about 3 cm³/g.

In one embodiment, the biomass-derived free standing 3D carbon hybrid electrode has an average pore radius of 1.9 to 2.5 nm, such as of about 1.9 nm, such as of about 2 nm, such as of about 2.1 nm, such as of about 2.2 nm, such as of about 2.3 nm, such as of about 2.4 nm, such as of about 2.5 nm.

In one embodiment, the biomass-derived free standing 3D carbon hybrid electrode has a micropore surface area of at least 40 m²/g or more, such as 50 m²/g or more, such as 60 m²/g or more, such as 70 m²/g or more, such as 80 m²/g or more, such as 100 m²/g or more, such as 150 m²/g or more, such as 200 m²/g or more, such as 500 m²/g or more, such as 1000 m²/g or more micropore surface area.

In one embodiment, the biomass-derived free standing 3D carbon hybrid electrode has a Brunauer-Emmett-Teller (BET) specific surface area of at least 5 m²/g or more, such as 20 m²/g or more, such as 50 m²/g or more, such as 100 m²/g or more, such as 200 m²/g or more, such as 300 m²/g or more, such as 400 m²/g or more, such as 500 m²/g or more, such as 700 m²/g or more, such as 1000 m²/g or more BET surface area.

In one embodiment, the biomass-derived free standing 3D carbon hybrid electrode has specific gravimetric capacitance of 5 to 3000 F/g of biomass-derived carbon weight.

In one embodiment the electrode has a specific gravimetric capacitance of 5 to 300 F/g as calculated of total electrode weight, such as 5 F/g, 50 F/g, 100 F/g, 150 F/g, 200 F/g or 250 F/g as calculated of total electrode weight.

In one embodiment, the electrode has a specific gravimetric capacitance of 50 to 3000 F/g as calculated of biomass derived carbon weight, such as 200 F/g, 400 F/g, 600 F/g 800 F/g, 1000 F/g, 1200 F/g, 1400 F/g 1600 F/g, 1800 F/g, 2000 F/g, 2200 F/g, 2400 F/g 2600 F/g or 2800 F/g or more, as calculated of biomass derived carbon weight.

In one embodiment, the biomass-derived free standing 3D carbon hybrid electrode, can function after being exposed to a crimping pressure of at least 50 bar.

Because of its free-standing properties with good mechanical strength, the biomass-derived free-standing 3D carbon hybrid electrode can be binder-free. In one embodiment, the biomass-derived free standing 3D carbon hybrid electrode does not comprise a binder material. In one embodiment, the biomass-derived free standing 3D carbon hybrid electrode is a binder-free electrode.

In one embodiment, the biomass-derived free standing 3D carbon hybrid electrode does not comprise an additional metallic current collector.

In one embodiment, the biomass-derived free standing 3D carbon hybrid electrode does not comprise any additional conductive agents such as carbon black or super P.

One aspect of the present disclosure provides for a battery comprising a biomass-derived free-standing 3D carbon hybrid electrode as described herein as one of its electrodes.

One aspect of the present disclosure provides for a supercapacitor comprising a biomass-derived free-standing 3D carbon hybrid electrode as described herein.

One aspect of the present disclosure provides for a coin cell comprising a biomass-derived free-standing 3D carbon hybrid electrode as described herein, wherein said electrode does not comprise a binder, and/or an additional metallic current collector. In one embodiment, the electrode is made in a shape to fit a coin cell.

One aspect of the present disclosure provides for the use of a biomass-derived free-standing 3D carbon hybrid electrode as described herein for energy storage, energy conversion, electrocatalysis, water and wastewater treatment, and/or CO₂ capture.

One aspect of the present disclosure provides for a free-standing hydrogel filled architectured polymeric template, wherein the hydrogel is made of a biomass-derived polymer, and wherein the template is a architectured polymeric template with a patterned three-dimensional open structure for use as adsorbent for water.

In one embodiment, the architectured polymeric template, the hydrogel, the aerogel, the biomass-derived polymer and the pyrolysis are as described elsewhere herein.

The methods of the present disclosure allow to make electrode in a form and shape suitable for using the obtained electrode in a battery of a specific shape, such as a coin cell, pouch cell or any shape necessary for the desired battery.

### Applications

One aspect of the present disclosure provides for a hydrogel-filled rationally designed polymeric template as described herein. One aspect of the present disclosure provides for an aerogel-filled rationally designed or architectured polymeric template as described herein.

One aspect of the present disclosure provides for a biomass-derived free-standing 3D carbon hybrid electrode comprising a pyrolyzed aerogel-filled rationally designed or architectured polymeric template.

These products find applications in various fields.

For example, a hydrogel-filled architectured polymeric template as described herein may be used for environmental applications, such as as adsorbent of organic and/or inorganic pollutants from water and/or wastewater. A hydrogel-filled architectured polymeric template as described herein has some advantages over traditional hydrogel adsorbents, for example, it has better mechanical strength due to the 3D polymeric template. Moreover, the use of 3D printing for making the polymeric template gives the possibility to tailor shape and size of the final hydrogel-filled polymeric template based on the demand.

Similarly, an aerogel-filled architectured polymeric template or biomass-derived free-standing 3D carbon hybrid electrode as described herein may be used for environmental applications, such as as adsorbent of organic and/or inorganic pollutants from water and/or wastewater.

The biomass-derived free-standing 3D carbon hybrid electrode comprising a pyrolyzed aerogel-filled architectured polymeric template is an efficient, green alternative to traditional carbon electrodes and can be successfully used in any application which requires carbon electrodes. For example, in supercapacitors and in batteries for storing energy, in electrocatalysis, in electrolysis and in fuel cells.

One aspect of the present disclosure provides for a battery comprising a biomass-derived free-standing 3D carbon hybrid electrode as described herein. In one embodiment, the biomass-derived free-standing 3D carbon hybrid electrode as described herein is at least one of the electrodes of the battery. In one embodiment, the biomass-derived free-standing 3D carbon hybrid electrode as described herein replaces the traditional graphite used as one of the electrodes in any of the rechargeable batteries.

In one embodiment, the battery is a Lithium Ion battery, a Sodium ion battery, or Zinc-Air battery.

In one embodiment, the electrode is made in a shape to fit a battery. For example, in one embodiment the electrode is made to fit the shape of a coin cell, a pouch cell or any other necessary shape.

One aspect of the present disclosure provides for a supercapacitor comprising a biomass-derived free-standing 3D carbon hybrid electrode as described herein.

One aspect of the present disclosure provides for a fuel cell comprising a biomass-derived free-standing 3D carbon hybrid electrode as described herein, wherein said electrode does not comprise a binder and/or an additional metallic current collector.

### Items

1. A method of producing a free-standing biomass-derived carbon hybrid electrode comprising:
   a. providing a rationally designed polymeric template with a patterned three-dimensional open structure,
   b. filling the template with a biomass-derived polymeric hydrogel,
   C. converting the biomass-derived polymeric hydrogel into an aerogel, and
   d. pyrolysing the aerogel-filled template to form a free-standing 3D carbon hybrid electrode.
2. The method according to anyone of the preceding items, wherein the step of providing the rationally designed polymeric template with a patterned three-dimensional open structure comprises 3D printing the polymeric template with a patterned three-dimensional open structure, such as by means of stereolithography (SLA) 3D printing, Digital Light Processing (DLP), projection micro stereolithography (PuSLA), Two-photon polymerization (2PP).
3. The method according to anyone of the preceding items, wherein the biomass-derived polymer is a polysaccharide-based polymer.
4. The method according to anyone of the preceding items, wherein the biomass-derived polymer is agarose, cellulose, chitosan, gelzan, pectin, lignin or alginate.
5. The method according to any one of the preceding items, wherein step b. comprises providing an inorganic compound.
6. The method according to any one of the preceding items, wherein step b. comprises precipitation of the inorganic compound in form of particles within the hydrogel-filled rationally designed polymeric template, such as wherein the inorganic compound particles are calcium hydroxide particles and/or calcium carbonate particles.
7. The method according to any one of the preceding items, wherein step c. comprises drying the hydrogel-filled rationally designed polymeric template using supercritical CO₂ drying, freeze drying, ambient drying, microwave drying or a combination thereof.
8. The method according to anyone of the preceding items, wherein step d. comprises pyrolyzing the aerogel-filled rationally designed polymeric template under a inert atmosphere at 700° C. or more, such as at 750° C. or more, such as at 800° C. or more, such as at 850° C. or more, such at 900° C. or more, such as at 950° C. or more, such as at 1000° C. or more, such as at 1100° C., such as at between 900° C. and 1100° C., for at least 10 seconds, such as for at least 1 minute, such as for at least 10 minutes, such as for at least 30 minutes, such as for at least 60 minutes, such for at least 80 minutes, such as for at least 90 minutes, such as for at least 120 minutes, such as for at least 180 minutes, thereby obtaining a biomass-derived carbon electrode.
9. A free-standing hydrogelfilled rationally designed polymeric template, wherein the hydrogel is made of a biomass-derived polymer, and wherein the template is a rationally designed polymeric template with a patterned three-dimensional open structure for use as adsorbent for water and wastewater treatment.
10. A biomass-derived free-standing 3D carbon hybrid electrode comprising a pyrolyzed aerogel-filled rationally designed polymeric template.
11. The biomass-derived free-standing 3D carbon hybrid electrode according to item 10, wherein the electrode comprises 3D interconnected frameworks of biomass-derived carbon aerogel.
12. The biomass-derived free-standing 3D carbon hybrid electrode according to any one of items 10 to 11, wherein the electrode is a monolithic structure, such as wherein the pyrolyzed aerogel-filled rationally designed polymeric template comprises carbon-carbon covalent bonds linking the pyrolzed rationally designed polymeric template and the pyrolyzed aerogel.
13. The biomass-derived free-standing 3D carbon hybrid electrode according to any one of items 10 to 12, wherein the electrode does not comprise a binder material.
14. The biomass-derived free-standing 3D carbon hybrid electrode according to any one of items 10 to 13, wherein the electrode does not comprise an additional metallic current collector.
15. A battery comprising a biomass-derived free-standing 3D carbon hybrid electrode according to any one of items 10 to 14, or a free-standing 3D carbon hybrid electrode obtained by the method according to any one of items 1 to 8.

### EXAMPLES

### Example 1: General Method for the Preparation of Biopolymer-BCAH (Biomass-Derived Carbon Aerogel Hybrids) Electrodes

### Materials and Methods

The biopolymers chitosan (Mw=50,000-190,000 Da, 20 to 300 cP for 1 wt. % in 1% acetic acid at 25° C.), agarose (Type I, low EEO), cellulose (2-Hydroxyethyl cellulose, average Mv=90,000, 75 to 150 cP for 5 wt. % in H₂O at 25° C.) and gelzan (gelrite or gellan gum) were obtained from Sigma-Aldrich, Germany. Seaweed-derived biopolymer sodium alginate (food grade, 25 cp, Fiber: 69.26% and M/G ratio=1.97%) was purchased from Loba Chemie, India. Algaia, France, kindly provided alginates with different viscosity and M/G ratios, and pectin (Classic CU 701 with an esterification degree of 36 to 40%, kindly provided by Herbstreith & Fox GmbH& Co, Germany). Chemicals such as calcium chloride (CaCl₂)·2H₂O), potassium chloride (KCl), hydrochloric acid (37% HCl), perchloric acid (HClO₄) and sulfuric acid (H₂SO₄) are purchased from Sigma Aldrich, Germany. Commercial photopolymer high-temperature V2 was procured from Formlabs Inc, USA. All the chemicals were used without further purification. All solutions were prepared using deionized water with a resistivity of 18.2 MΩ·cm obtained from a Milli-Q water purification system (Millipore Co., Billerica, USA), including the solution used for electrochemical characterization.

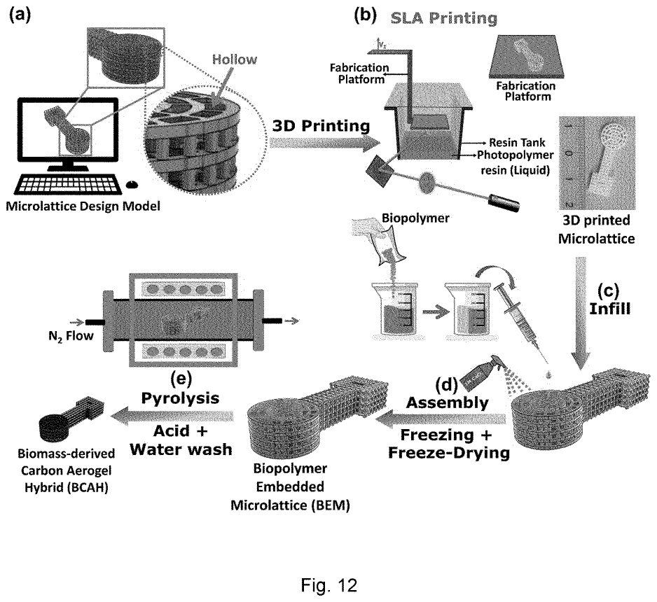

An overview of the method is schematically depicted in FIG. 12.

Design, slicing and 3D printing. The 3D models of the architected microlattices were designed using Fusion 360 (Education License, V. 2.0.5511, Autodesk, Inc). In this work, an electrode shape with a spider-web design for the active area and a meshed connection part was designed. Based on previous work, a mesh with vertical and horizontal cylindrical connections (0.4 mm diameter and 0.7 mm mesh spacing) was chosen as the optimal design to ensure good structural integrity of the electrodes even after pyrolysis. After creating the designs, the files were exported as stereolithography (.stl) files and loaded into the 3D printer software (PreForm Software V. 2.18.0, Formlabs, USA), where the 3D model was sliced into printable 2D layers. The as-designed 3D models were printed using a Formlabs 2 SLA 3D printer (Formlabs Inc., USA), which has a laser wavelength of 405 nm and a maximum power of 150 mW. The architected electrode structures were printed directly on a 6-inch silicon wafer substrate mounted on the printer platform using a photosensitive resin (High Temp Resin V2, Formlabs, USA). This ensured the uniformity and repeatability of the printed structures and easy release of the 3D printed microlattices from the substrate. After printing, the 3D microlattices were released from the platform and washed gently with isopropyl alcohol (IPA) to remove any uncross-linked resin monomers (Form Wash, Formlabs, USA). Finally, the constructs were post-cured under UV light at room temperature for 30 mins (Form Cure, Formlabs, USA).

Preparation of biopolymer embedded microlattices (BEM). Biopolymer embedded microlattices (BEM) were obtained through the microlattice assisted self-assembly (MASA) process, followed by crosslinking, freezing and freeze-drying. Firstly, a homogenous solution of biopolymers was prepared by dissolving 1.5 g of biopolymer powder in 100 mL of deionized water under magnetic stirring at room temperature except for agarose. Agarose solution was prepared by dispersing 1.5 g of the polymer in 100 mL hot deionized water while constantly stirring at 80° C. until no solid particles were observed. After complete dissolution, a known volume of the homogenous biopolymer solution was injected into the oxygen plasma-treated 3D printed microlattices, followed by self-assembly of biopolymer confined within the microlattice into hydrogels via physical or chemical crosslinking based on the type of biopolymer injected.

The polymers were crosslinked based on the conditions listed in Table 1.

TABLE 1
Crosslinking conditions for the various biopolymers employed.

| | Type of crosslinking | |
|---|---|---|
| Biopolymer | method | Conditions |
| Agar | Physical | Allow gelation of the |
| | | injected hot agarose to |
| | | proceed at room |
| | | temperature |
| Cellulose | Physical | Self-assemble for three |
| | | days |
| Chitosan | Chemical | 1% (w/v) sodium |
| | | hydroxide (NaOH) solution |
| Pectin | Chemical | 1M CaCl₂ solution |
| Gelzan | Chemical | 1M CaCl₂ solution |
| Alginate | Chemical | 1M CaCl₂ solution |

To maintain the structural integrity of the biopolymer infilled in the 3D printed microlattice, chemical crosslinking was carried out by spraying the respective chemical cross-linkers and immersing the so-obtained BEM in a cross-linker bath for 15 min to ensure complete crosslinking. The immersed microlattice were then withdrawn from the cross-linker bath, washed thrice with deionized water and then left in deionized water for 10 min to remove uncrosslinked/excess cross-linker. The obtained BEM were subsequently frozen using dry ice for 2 h, lyophilized for 18 h and stored in a nitrogen atmosphere until further use.

Preparation of biomass-derived carbon aerogel hybrids (BCAH). The BEM obtained via the MASA process, followed by crosslinking, freezing and freeze-drying, were pyrolyzed at 900° C. in a horizontal tubular ceramic furnace (OTF-1200X, MTI Corporation, USA) under a continuous nitrogen flow of 200 sccm throughout the process. The pyrolysis process was optimized based on the Thermographimetric analysis (TGA) results of the microlattice, such that electrodes with good structural integrity were obtained.

The pyrolysis process for BCAH was as follows:
(1) heating from room temperature to 410° C. with a heating rate of 2° C. min-1;
(2) dwell at 410° C. for 1 h;
(3) heating from 410 to 900° C. with a ramping rate of 3° C. min-1; dwell at 900° C. for 3 h and
(4) cooling down to room temperature at 5° C. min-1.

Following carbonization, all the samples were washed with 1M HCl under vacuum for 6 h, rinsed several times with water to remove HCl and dried at 40° C.

### Example 2: Physical Characterisation of the BCAH Electrodes Via Scanning Electron Microscopy (SEM)

Materials and methods

The structural and cross-section morphologies of the BEM and BCAH electrodes were observed by scanning electron microscopy (SEM, Zeiss Sigma VP). The samples were coated with gold using a sputter coater (E-1010 Ion Sputter) and imaged with SEM at 5 kV acceleration voltage.

### Results

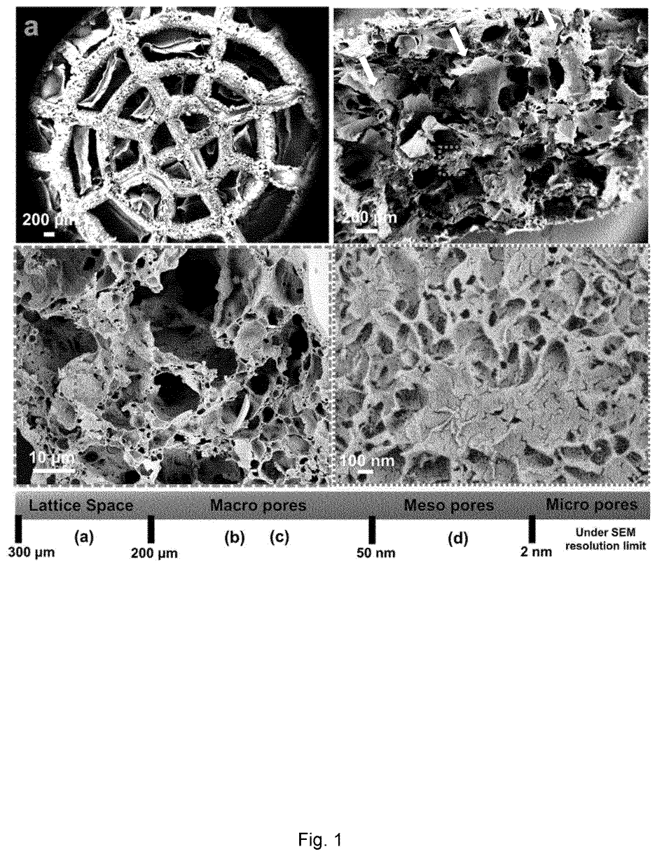

FIG. 1 presents the morphological characteristics of Alginate-BCAH. FIG. 1a reveals the top view of a multi-scale architected BCAH electrode with a spider-web design conveying the presence of AlginateBCA in the carbon microlattice. The cross-sectional images (FIG. 1b-d) demonstrate that AlginateBCAH electrodes have an interconnected 3D hierarchical porous network structure consisting of macro-, meso- and micropores formed during the self-assembly of the biopolymers on the microlattice.

### Conclusion

The electrodes according to the present disclosure present an open three-dimensional structure with an interconnected 3D hierarchical porous network consisting of marco-, meso- and micropores.

### Example 3: Electrochemical Characterization of the Different BCAH Electrodes Via Cyclic Voltammetry and Galvanostatic Charge-Discharge (GCD)

### Materials and Method

A three-electrode system was used to characterize the electrochemical performance of the alginate-based free-standing BCAH as the working electrode. Saturated Ag/AgCI calomel electrodes and double-sided platinum-coated silicon substrates (2×1 cm) were used as the reference and counter electrode, respectively, and 2M KCl solution as the electrolyte. Cyclic voltammetry and GCD were conducted on an Autolab electrochemical workstation (PGSTAT-302 N, Metrohm) at room temperature. Prior to the electrochemical tests, electrodes were subjected to plasma activation and left in the electrolyte under vacuum for 10 minutes to ensure good wetting of the electrode with the electrolyte. The gravimetric (C_{g}, F g⁻¹), areal (Cₐ, F cm⁻²) and volumetric (C_{V}, F cm⁻³) specific capacitance were calculated from the corresponding GCD curves according to Equations (1), (2) and (3), respectively:

$${C}_{g} = \frac{{I}_{d} {t}_{d}}{m Δ V} \qquad ( 1 )$$

$${C}_{a} = \frac{{I}_{d} {t}_{d}}{a Δ V} \qquad ( 2 )$$

$${C}_{v} = \frac{{I}_{d} {t}_{d}}{v Δ V} \qquad ( 3 )$$

where I_{d} is the discharge current (Ampere, A), ta is the discharge time (seconds, s), ΔV is the working electrochemical window (volts, V), m, a and v are the mass, area and volume of the active part of the electrode, which is the circle part of the BCAH (g, cm² and cm³, respectively).

### Results

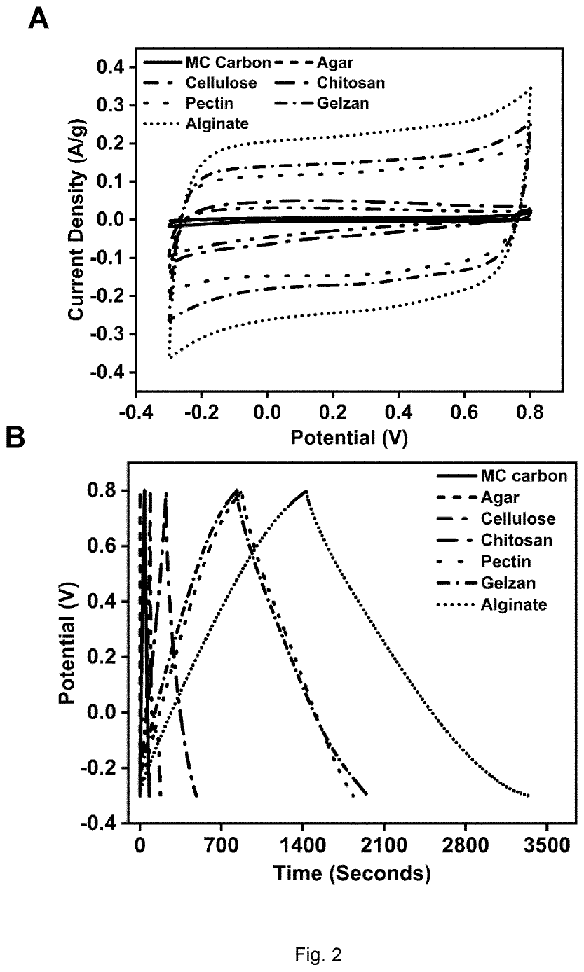

From FIG. 2a, it is observed that the alginate-based BCAH free-standing electrode displayed a rectangular-shaped CV at a scan rate of 5 mV s⁻¹ in 2M KCl electrolyte. The appropriate isosceles triangle shape of GCD curves of the alginate BCAH electrode (FIG. 2b) confirms a typical electric double layer capacitor (EDLC) behaviour and charge transfer. A higher discharge time is advantageous for the application of the electrodes in supercapacitors and batteries. These results show that different biopolymers are adequate for the preparation of BCAH according to the present disclosure. Alginate displayed the highest discharge time.

### Conclusion

The CV and GCD curves of the different BCAH electrodes fabricated from different polysaccharide-based biopolymers according to the present disclosure confirm their potential as free-standing electrodes for capacitive electrochemical energy storage.

### Example 4: Raman Analysis of the Different BCAH Electrodes

### Materials and Methods

Raman spectra were collected using a micro-Raman system (Thermo Scientific Nexsa, USA) with a laser wavelength of 532 nm.

### Results

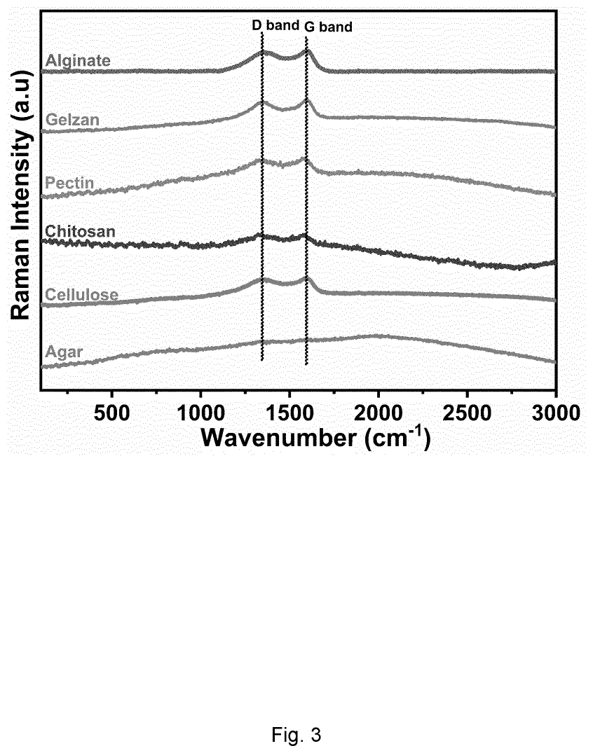

The Raman spectra (FIG. 3) exhibited two distinct peaks at 1356 cm⁻¹ (D-band) and 1595 cm⁻¹ (G-band), confirming the presence of disordered carbon (sp3) or defects and the vibration of ordered sp2 hybridized carbon, respectively. The relative intensity ratio of G-band and D-band (IG/Ip) provides information on the degree of graphitic ordering of the respective carbon. When there is more graphitic ordering carbon materials have better conductivity. For application as electrodes, a value of around 1 or more is appropriate. The IG/Ip for the different BCAH electrodes is shown in Table 2.

TABLE 2
Ratio of I_{G}/I_{D} peaks in the Raman spectra of
BCAH prepared with different biopolymers.

| Biopolymer | I_{G}/I_{D} ratio |
|---|---|
| Agar | N/A |
| Cellulose | 0.99 |
| Chitosan | 1.00 |
| Pectin | 1.01 |
| Gelzan | 1.01 |
| Alginate | 1.03 |

### Conclusion

The Raman analysis of the electrodes according to the present disclosure confirms that all electrodes have a distinct IG/Ip ratio based on the type of biopolymer embedded within the polymer template. The value for all electrodes except agarose is approximately 1, which is sufficient for capacitive energy storage.

### Example 5: Comparison of the Electrolyte Influence on the Specific Capacitance and Discharge Time for the Alginate-BCAH Electrode

### Materials and Methods

The electrochemical behaviour (discharge time and specific capacitance) was studied in different aqueous electrolytes using an adapted protocol of example 3. The electrolytes tested were: 2M KCl, 1M H₂SO₄ and 1M HClO₄.

### Results

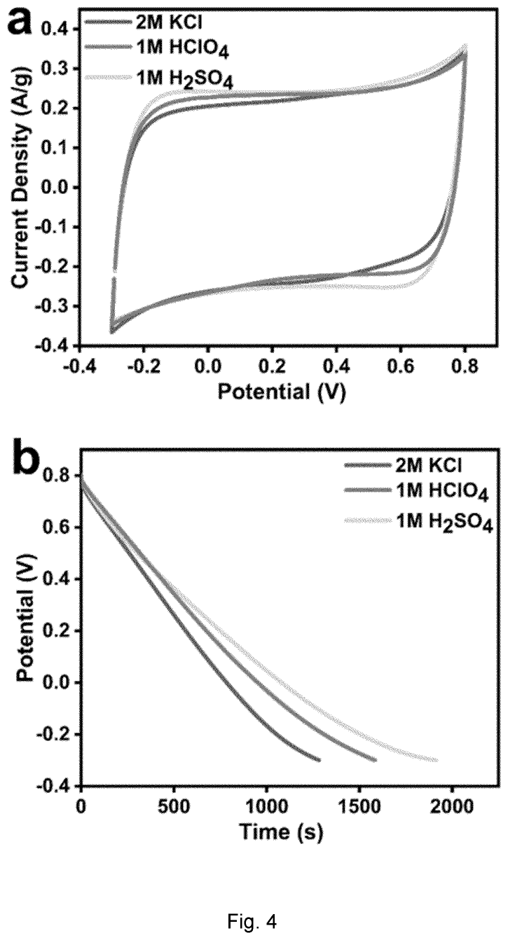

Alginate-BCAH showed good capacitive behaviour and similar rate capability in all electrolytes (FIG. 4, Table 3) attributed to the remarkable interfacial contact between the electrode and electrolyte. However, Alginate-BCAH electrodes exhibited a slightly higher area under the curve in 1M H₂SO₄, indicating higher capacitance.

TABLE 3
Specific capacitance and discharge time of Alignate-
BCAH electrodes in different electolytes.

| | | Specific | |
|---|---|---|---|
| | | capacitance | Discharge time |
| | Concentration | (current density of | (current density |
| Electrolyte | (M) | 0.5 mA cm −2) | of 0.5 mA cm⁻²) |
| KCl | 2 | 63.90 | 1282.4 |
| H₂SO₄ | 1 | 95.26 | 1911.6 |
| HClO₄ | 1 | 78.94 | 1584.2 |

### Conclusion

The CV and GCD curves of Alginate-BCAH electrode according to the present disclosure in different electrolytes confirm that Alginate-BCAH showed good capacitive behaviour and similar rate capability in all electrolytes, attributed to the remarkable interfacial contact between the electrode and electrolyte. However, Alginate-BCAH electrodes exhibited a slightly higher area under the curve in 1M H₂SO₄, indicating higher capacitance.

### Example 6: Long-Term Cycling Performance of the Alginate-BCAH Electrodes

### Materials and Methods

The electrodes were subjected to up to 3000 galvanostatic charge-discharge cycles at a high current density of 10 mA cm⁻² according to the GCD conditions described in Example 3.

### Results

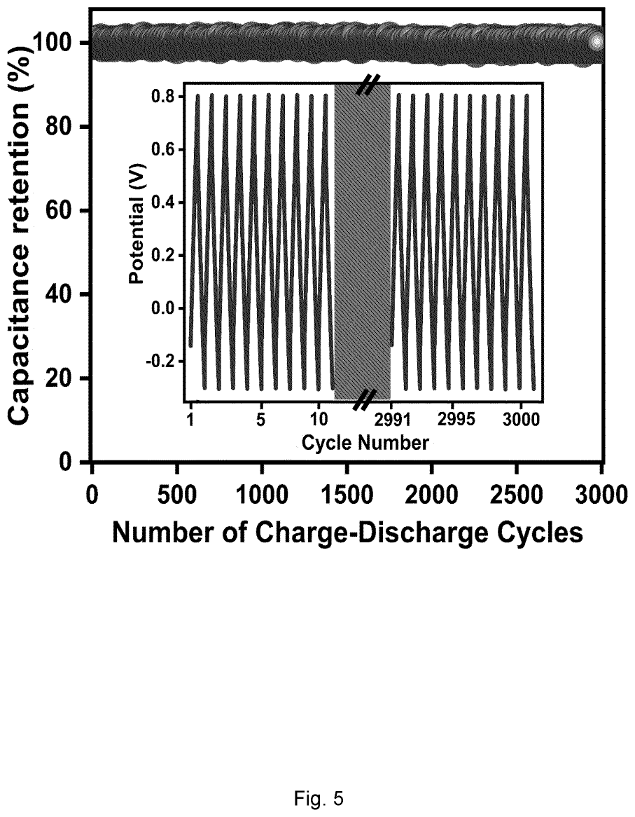

The electrodes showcased 99.5% capacitance retention upon 3000 cycles at a high current density of 10 mA cm⁻², confirming their potential as free-standing electrodes for electrochemical energy storage (FIG. 5).

### Conclusion

The BCAH electrodes of the present disclosure display excellent capacitance retention upon successive charge-discharge cycles.

### Example 7: Surface Composition Based on XPS

### Materials and Methods

The chemical bonding information was obtained from X-ray photoelectron spectroscopy (XPS) measurements conducted using the Thermo Fischer K-alpha XPS system (Thermo Fischer Scientific Inc., USA) equipped with a monochromatic Al-Kα X-ray source at pass energy of 200 eV.

### Results

The results displaying the surface composition for microlattices before pyrolysis and different biomass-derived aerogels without a microlattice are displayed in the table 4.

TABLE 4
XPS results for microlattice and different biomass-derived aerogels

| | Atomic Ratio (%) | | | | | O/C |
|---|---|---|---|---|---|---|
| Sample | C 1s | O 1s | Ca 2p | Cl 2p | N1s | ratio (%) |
| Microlattice | 66.25 | 25.25 | | | 8.5 | 38.11 |
| Alginate | 65.46 | 29.8 | 4.38 | 0.51 | — | 45.52 |
| Gelzan | 91.48 | 4.55 | 3.56 | 0.42 | — | 4.97 |
| Pectin | 92.8 | 3.41 | 3.13 | 0.81 | — | 3.67 |
| Chitosan | 90.97 | 6.57 | | | 2.45 | 7.22 |
| Cellulose | 94.55 | 5.45 | — | — | — | 5.76 |
| Agarose | 91.92 | 8.08 | — | — | — | 8.79 |

The results displaing the surface composition of microlattices and alginate BCAH after pyrolysis are displayed in the table 5.

TABLE 5
XPS results for Alginate-BCAH after pyrolysis.

| | Atomic ratio C | Atomic ratio O | O/C ratio | I_{G}/I_{D} |
|---|---|---|---|---|
| Sample | 1 s (%) | 1 s (%) | (%) | ratio |
| MC | 96.18 | 3.82 | 3.97 | 0.994 |
| Alginate-BCAH | 91.55 | 8.45 | 9.23 | 1.03 |

### Conclusion

The XPS results of different BCAH electrodes of the present disclosure revealed the surface composition of different polymer aerogels and the successful graphitization of alginate aerogel-filled microlattices into a robust hierarchical 3D interconnected graphitic framework of Alginate-BCAH.

### Example 8: BET Surface Area

### Materials and Method

The surface area and porosity of the prepared BCAH electrodes were investigated using Quantachrome Autosorb 1, USA, at liquid nitrogen temperature based on the Brunauer-Emmett-Teller (BET) method in the relative pressure (P/P0) range of 0.05 to 1.

### Results

The introduction of biopolymer resulted in a 10-fold increase of the BET specific surface area and total pore volume of the BCAH electrode compared to the corresponding carbon microlattice without biopolymer as shown in the table 6.

TABLE 6
BET results for Alginate-BCAH.

| | BET Surface area, | Total pore volume, |
|---|---|---|
| Name of Sample | S_{BET} [m² g⁻¹] | V_{T} [cm³ g⁻¹] |
| Microlattice | 10.89 | 0.012 |
| Alginate-BCAH | 114.4 | 0.12 |

### Conclusion

The BET results of Alginate-BCAH electrodes of the present disclosure revealed that it possessed a hierarchical porous structure with a significant quantity of micropores, suitable mesopores and a massive amount of interior macropores along with the architected macrostructure designed in the 3D printing process.

### Example 9: Introducing Mineralization to BCAH Electrodes

### Materials and Methods

The mineralized BCAH electrodes where obtained by a similar method as reported in example 1 with the addition of an in-situ mineralization step.

In-situ mineralization. In-situ mineralized alginate embedded microlattices (iMAEM) were obtained through the process mentioned in Example 1 combined with in-situ mineralisation, followed by freezing and freeze-drying. Firstly, a homogenous sodium alginate solution was prepared by dissolving 1.5 g of biopolymer powder in 100 ml of 1M KOH solution under continuous magnetic stirring at room temperature. After complete dissolution, 225 μL of the homogenous alginate solution was infilled into the oxygen plasma-treated 3D printed microlattices. Upon spraying with 1M CaCl₂), alginate inside the microlattice undergoes self-assembly and chemical cross-linking, and transforms into a hydrogel within the microlattice space. Simultaneously, the OH-ions molecularly dispersed within the alginate matrix reacted with Ca²⁺ ions to form Ca(OH) 2, which readily absorbed CO₂ from the air to form calcium carbonate (CaCO₃) particles within the alginate hydrogel network. To maintain the structural integrity of the in-situ mineralised alginate in the 3D printed microlattice, the constructs were left in a 1M CaCl₂) bath for 15 min after spray cross-linking. This ensured the complete crosslinking of alginate and the in-situ formation of CaCO₃ hierarchical microstructures within the hydrogel network. Subsequently, the immersed microlattice was then withdrawn from the cross-linker bath, washed thrice with deionised water, and left in deionised water for 10 min to remove uncrosslinked/excess CaCl₂) cross-linker, frozen using dry ice for 2 h and lyophilised for 18 h to yield iMAEM. The as-obtained iMAEM was stored in a nitrogen atmosphere until further use. Similarly, the same method was used to prepare iMAEM with different alginate weight content (1%, 2%, 3% and 5%).

The resulting iMAEM, were processed by pyrolysis into carbon electrodes as described in example 1.

The resulting mineralized alginate-derived carbon aerogel electrode hybrids (iMACAH) were characterized for their pore structure, raman scattering, XPS, N₂ absorption isotherms and electrochemical performance as described in the examples above. Results were compared with non-mineralized counterparts (alginate carbon aerogel hybrids, ACAH) and also non-mineralized counterparts that were activated with KOH treatment (ACAH (KOH)).

### Results

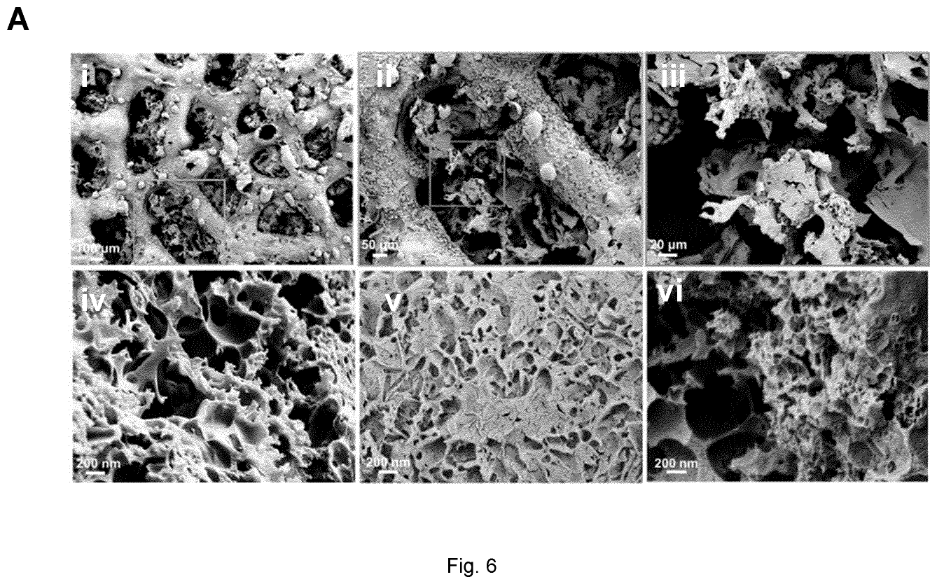

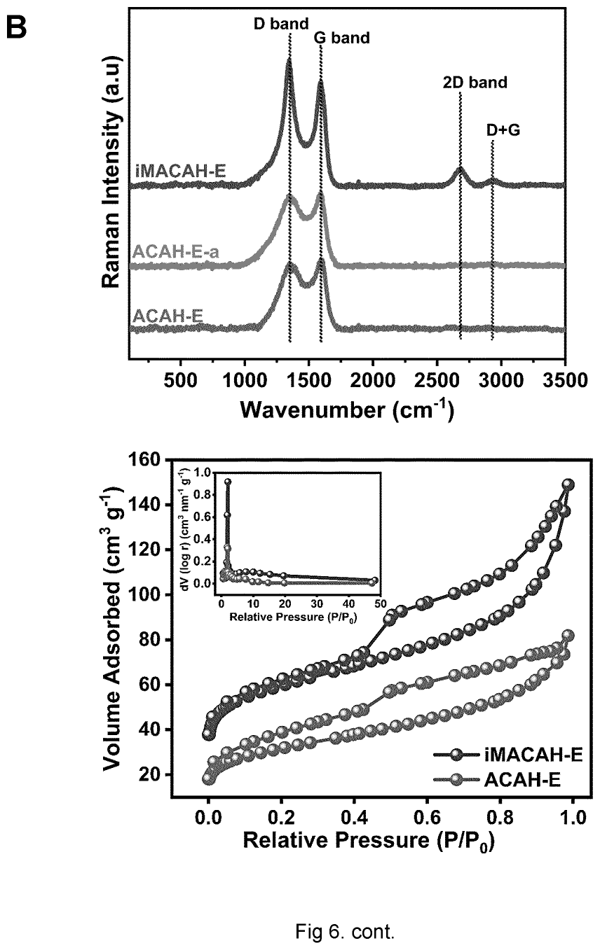

The Raman spectra of all the prepared electrodes showed a strong characteristic D band at around 1346 cm⁻¹ and G-band at 1594 cm⁻¹, corresponding to the disordered structure caused by the carbon lattice defects and sp2 carbon-bonded ordered graphitic structure, respectively (FIG. 6). The IG/Ip intensity ratios of ACAH, ACAH (KOH) and iMACAH, were calculated to be 1.03, 1.02 and 1.0, respectively. Furthermore, Raman spectra of iMACAH showed two additional peaks at around 2682 and 2926 cm⁻¹, assigned to the 2D band (an overtone of the D band) and D+G band (a combination of the D and G band), respectively. The markedly broadened 2D, as well as the calculated I_{G}/I_{2D} of 1.49, indicates a highly porous graphitic structure of iMACAH with few layers of graphene and high prevalence of structural disorder and defects. Thus, iMACAH had a high graphitisation structure, confirming that the in-situ mineralization strategy enriches iMACAH electrodes with oxygen defects which can be used as active sites and were reflected in their final electrochemical performance.

The N₂ adsorption/desorption isotherm curve of ACAH and iMACAH presented itself with typical type-IV adsorption (FIG. 6). Compared with ACAH, the IMACAH electrode exhibited a much larger BET surface area of 218.13 m² g⁻¹ (114.4 m² g⁻¹ for ACAH) and a larger total pore volume of 0.23 cm³ g⁻¹ (0.12 cm³ g⁻¹ for ACAH), of which 0.05 cm³ g⁻¹ (0.02 cm³ g⁻¹ for ACAH) was attributed to micropores as shown in Table 7. The iMACAH electrodes prepared with mineralization possessed a higher accessible specific surface area (SSA), larger pore volume and relatively wider pore size distribution with mainly larger pores around 1 nm, which are conducive to electrolyte permeation and ion adsorption, thus potentially improving the energy storage capacity.

TABLE 7
BET results for ACAH electrode and iMACAH.

| | | | Average | Micropore | |
|---|---|---|---|---|---|
| | BET | Total pore | pore | surface | Micropore |
| | surface | volume | radius | area | volume |
| Sample | area (m² g⁻¹) | (cm³ g⁻¹) | (nm) | (m²g⁻¹) | (cm³g⁻¹) |
| ACAH | 114.4 | 0.12 | 2.08 | 51.29 | 0.02 |
| iMACAH | 218.13 | 0.23 | 2.39 | 128.22 | 0.05 |

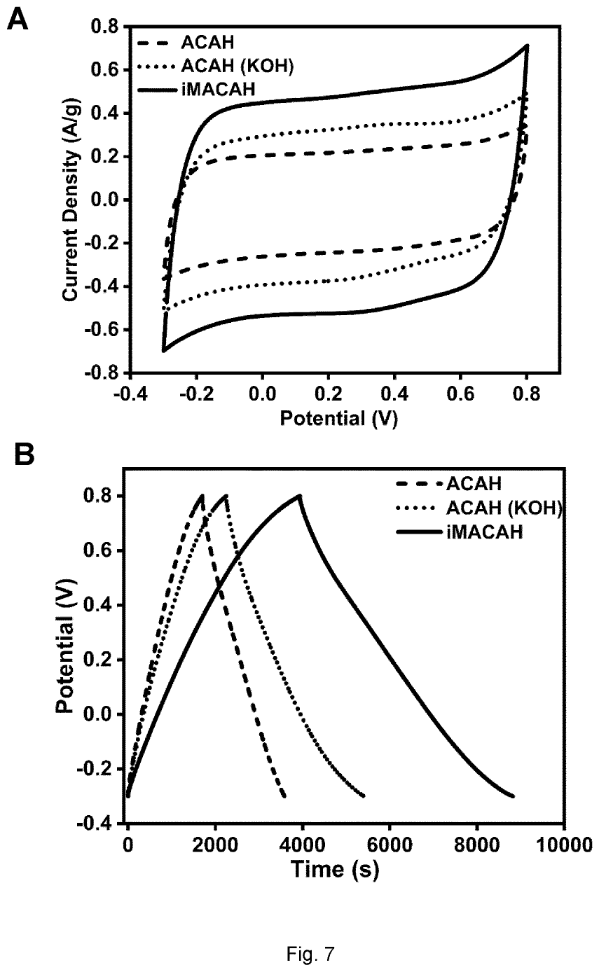

FIG. 7A shows the CV of the as-fabricated ACAH, ACAH (KOH) and iMACAH electrodes at 5 mV s⁻¹ with a typical rectangular-like shape, indicating exemplary capacitive behaviour. Compared to ACAH prepared without mineralization, iMACAH prepared with the mineralization approach displayed a rectangular-shaped CV with a remarkably larger enclosed area and longer discharging times as seen from GCD curves depicted in FIG. 7B, obtained at 0.5 mA cm⁻².

Conventionally and in most reported studies, the specific capacitance of state-of-the-art BCA-based supercapacitor electrodes is calculated without considering the mass of the additional current collector, conductive agents, and polymer binder. However, in principle, the mass of these inactive components, which form an integral part of the SC electrode, should also be considered while calculating the capacitance. Thus, to have a more practical and realistic value, the gravimetric capacitance (C_{g}) of all the electrodes is calculated by considering the total weight of the electrode, including both the 3D carbon microlattice and the BCA-based electroactive material (Table 8). The iMACAH electrode showcased a specific capacitance of 241.7 F g⁻¹, superior to those of ACAH (95.3 F g⁻¹) and ACAH (KOH) (158.9 F g⁻¹). Additionally, to have a reasonable comparison of the capacitances with reported values, the C_{g} was recalculated by considering only the mass of the BCA material. The resulting C_{g_biomass} of MACAH was 2819.7 F _{g_carbonizedbiomass-1} and surpassed ACAH (547.74 F _{g_carbonizedbiomass} ⁻¹) and postKOH activated ACAH (KOH) (1112.67 F _{g_carbonizedbiomass-1}) counterparts as well as all the state-of-the-art BCA-based SC electrodes so far reported in the literature.

The specific mass of the BCA material was obtained by weighing 10 BCA materials and taking the average of their weight.

TABLE 8
Specific capacitance of electrodes.

| | Capacitance | Capacitance |
|---|---|---|
| Sample | (F g_{—}_{totalweight}⁻¹) | (F g_{—}_{carbonizedbiomass}⁻¹) |
| ACAH | 95.3 | 547.7 |
| ACAH-KOH | 158.9 | 1112.7 |
| iMACAH | 241.7 | 2819.7 |

In addition, the areal and volumetric capacitance of iMACAH were found to be 3.10 F cm⁻² and 59.05 F cm⁻³, which is significantly higher than the traditional thin-film electrodes owing to the enhanced surface area within the same footprint.

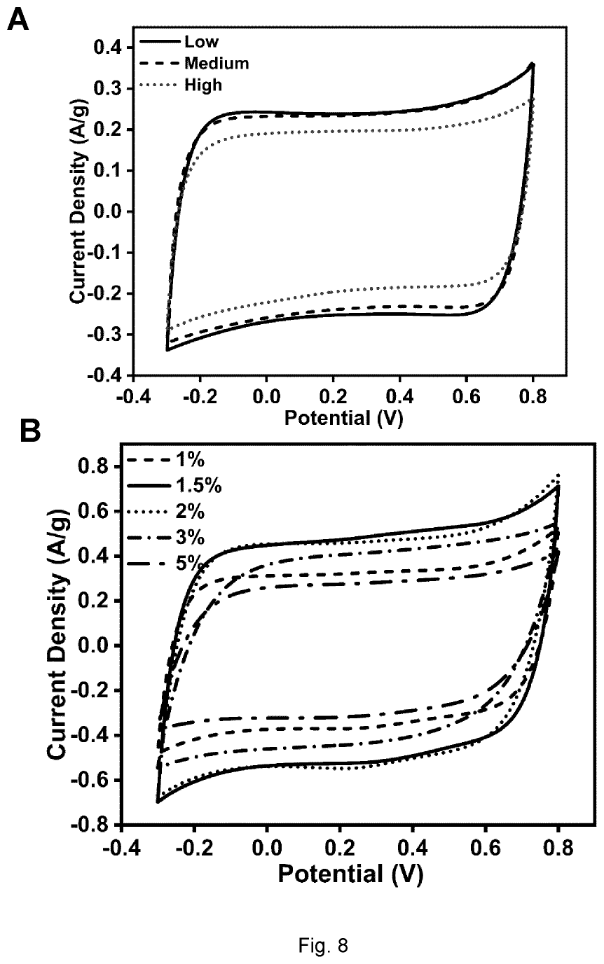

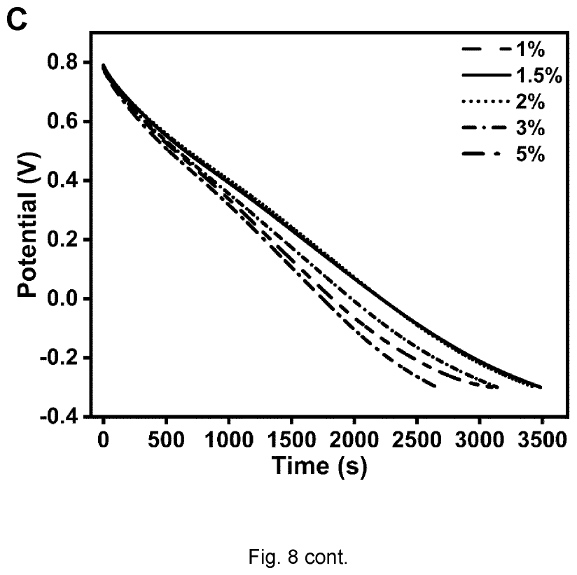

The effect of alginate type and content was also considered. Samples were prepared as described above with three different alginate types (low, medium and high viscosity). All types of alginate produced successful carbon electrodes. Low and medium viscosity alginates gave a similar electrochemical behaviour, while alginate with high viscosity had a slightly reduced electrochemical performance, as shown in FIG. 8A.

IMACAH electrodes prepared with solutions with different wt % of alginate were also studied. The electrochemical performance of electrodes prepared from 1.5% and 2% solutions of alginate showed similar performance. Electrodes prepared at 1%, 3% and 4% displayed slightly lower electrochemical performance (FIGS. 8B and C).

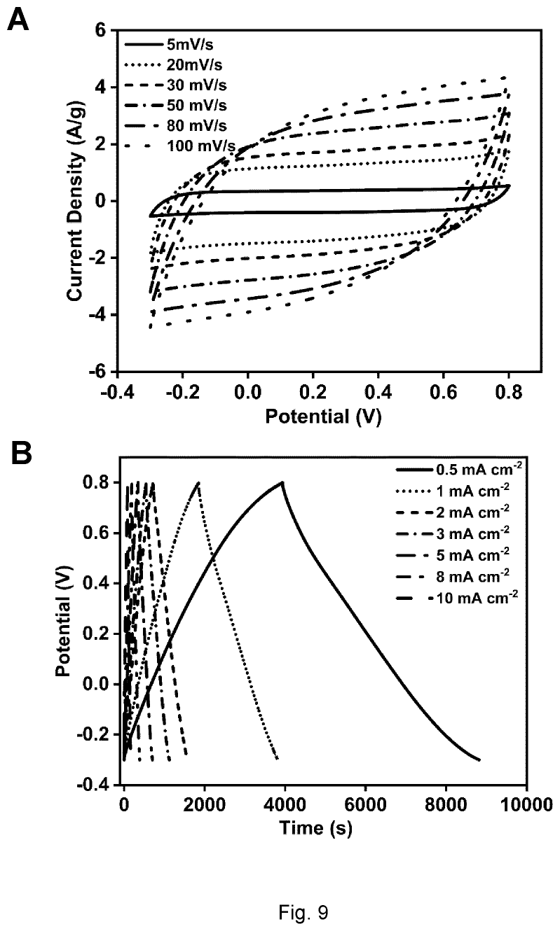

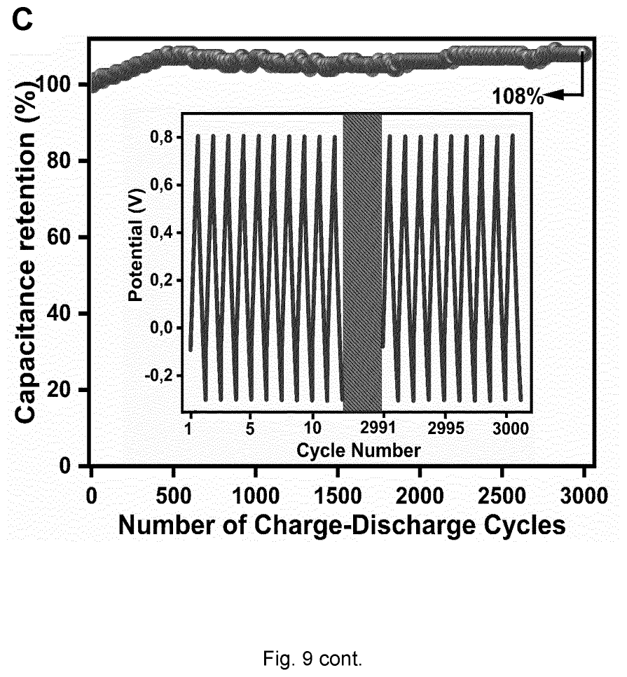

The electrochemical kinetics of the optimized iMACAH were further investigated by recording CV at different scan rates ranging from 5 to 100 mV s⁻¹ (FIG. 9a). The well-defined quasirectangular shaped CV obtained even at the highest scan rate of 100 mV s⁻¹, along with a symmetric triangular GCD with a negligible ohmic drop (FIG. 9b), indicates that the electrical double layer with highly reversible and kinetically facile charge-discharge responses plays the decisive role in determining the capacitive characteristics. The long-term cyclic stability of iMACAH electrodes was measured using GCD at a current density of 10 mA/cm⁻². As illustrated in FIG. 9c, the superior capacitance of iMACAH electrodes was maintained with 108% capacitance retention upon 3000 cycles, demonstrating their potential as free-standing electrodes for electrochemical energy storage. Interestingly, the trend of the increasing capacitance during the repeated cycling process, even at a high current density of 10 mA/cm⁻² is ascribed to the pore size distribution in the multi-scale architected hierarchical porous structure of iMACAH. The CV and charge and discharge profiles before and after long-term cycling remained unchanged.

### Conclusion

These results confirm that the in-situ mineralization translated into enhanced microporosity during the conversion of polysaccharides into carbon by acting as hard template, activating agent and graphitisation catalyst.

Therefore, on account of the full utilisation of the pores with increased charge-discharge cycles, iMACAH electrode material tends to reach a stable capacitance value, demonstrating outstanding cyclic stability and reversibility.

### Example 10: Comparison with Electrodes Fabricated with Carbon Coming from Non-Biomass Sources

### Materials and Methods

Carbon electrodes prepared from different carbon sources were prepared as described below. Two different carbon sources were studied: graphene oxide (GO) and resorcinol-formaldehyde hydrogel.

Graphene oxide as carbon source. For the graphene carbon aerogel hybrid electrodes (G-CAH-E) 0.5% and 1% graphene oxide solution were prepared. A known volume of 225 μl of each of the above solution was injected into the 3D printed scaffold. For crosslinking, GO was cross-linked using CaCl₂). The samples were freezed and freeze-dried. The so-obtained aerogel embedded scaffolds were then pyrolyzed at 900° C., followed by acid washing for 6 hrs, water wash and drying before use.

Resorcinol-formaldehyde hydrogel as carbon source. For the resorcinol-formaldehyde carbon aerogel hybrid electrodes (RF-CAH-E) 1.5% RF gel solution was prepared using ammonium hydroxide and the cross-linked RF gel was injected into the 3D scaffold. The samples were freezed and freeze-dried. The so-obtained aerogel embedded scaffolds were then pyrolyzed at 900° C., followed by acid washing for 6 hrs, water wash and drying before use.

### Results

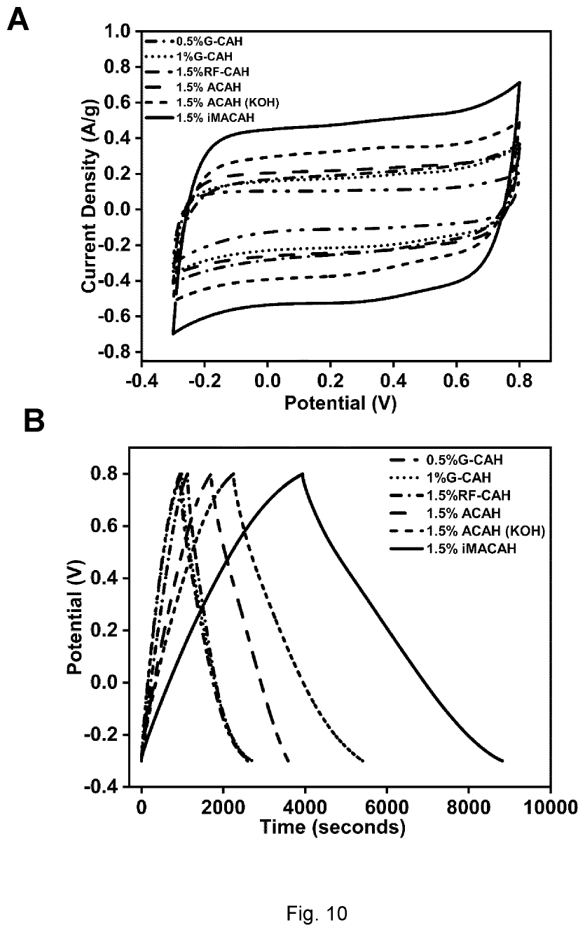

The results shown in FIG. 10 demonstrate that the biomass-derived electrodes displayed a better electrochemical performance when compared to other sources of carbon.

### Conclusion

The comparison of iMACAH electrodes prepared with biomass-derived alginate biopolymer of the present disclosure with CAH electrodes prepared with other carbon sources obtained from petroleum derived sources such as graphene oxide and Resorcinol formaldehyde (RF) in a similar way as stated in example 1, confirms that biomass-derived polymer derived electrodes display better electrochemical capacitive performance than those obtained from petroleum derived graphene or resorcinol-formaldehyde as precursors.

### Example 11: Effect on Electrode Thickness and Mechanical Stability

### Materials and Methods

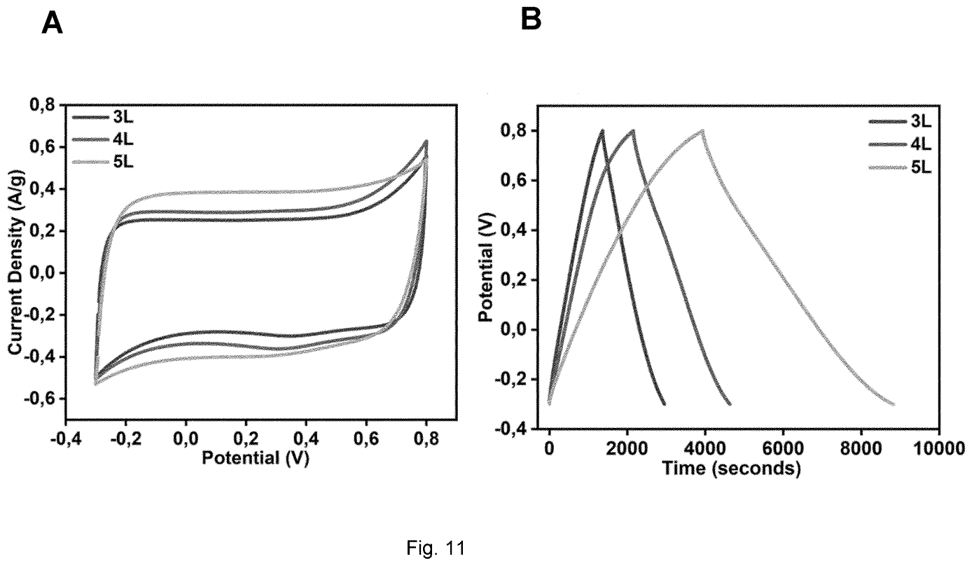

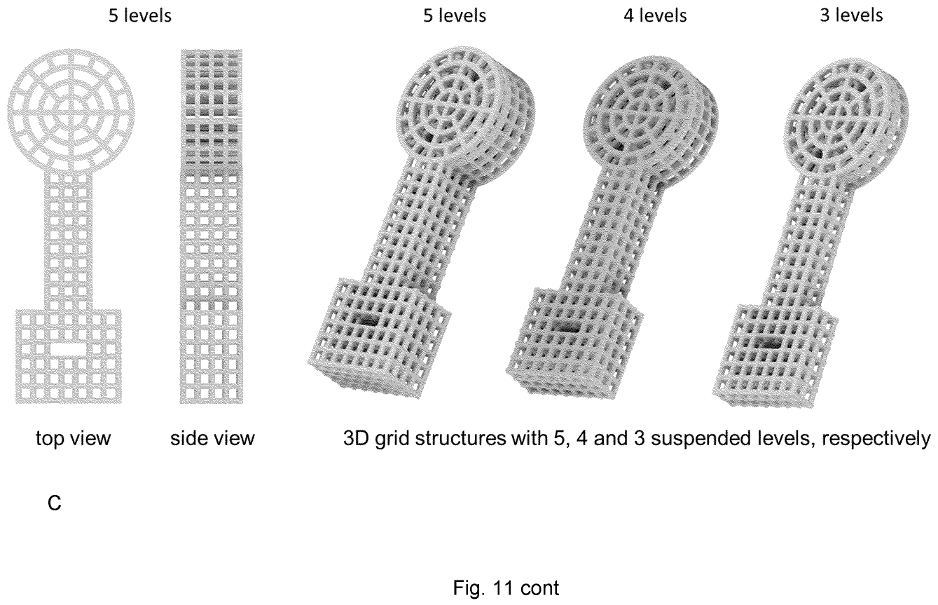

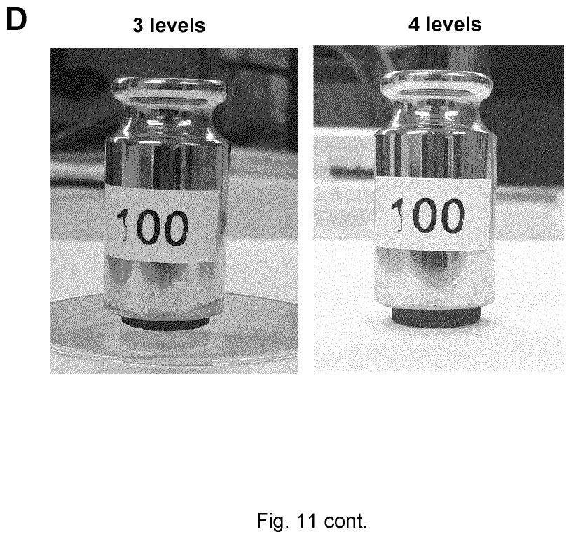

The iMACAH electrodes with different thickness where obtained by a similar method as reported in example 9 by using 3D printed scaffolds with specified number of microlattice structural levels varying from 3 to 5 (See FIG. 11C).

### Results

The results show that the thicker the template, the higher the amount of biomass-derived polymer used for infilling the scaffolds. Consequently, the higher the electrochemical active material as seen from the higher current response in CV and longer discharge time in GCD as seen in the table below and FIG. 11.

Additionally, the electrodes display excellent mechanical stability. Placement of 100 g on top of the electrodes did not produce any damage (FIG. 11D).

### Conclusion

The iMACAH electrodes of the present disclosure with different thickness were prepared by using 3D printed polymeric templates with different number of microlattice structural levels (or “layers” in FIG. 11C) varying from 3 to 5. The results showed that the thicker the 3D printed scaffold, the higher the amount of biomass-derived polymer used for infilling the scaffolds. Consequently, this results in a higher amount of electrochemically active material as seen from the higher current response in CV and longer discharge time in GCD (FIGS. 11A and 11B). Moreover, having a scaffold with 5 structural levels (layers) provides better current collection, thereby showing the potential of the electrodes according to the present disclosure for electrochemical applications.

### Example 12. Use of Electrodes of the Present Disclosure in Batteries

Materials and methods

In order to evaluate the feasibility of using the developed 3D hybrid carbon electrodes as alternative electrode materials in ion batteries, specifically in this case lithium-ion batteries (LIBs), the electrodes were designed in a way to fit into the conventional coin cell (CR 2032). For this aim, polymeric templates with spider-web-like grid structures were designed and the models were printed using a Formlabs 2 SLA 3D printer (Formlabs Inc., USA), which has a laser wavelength of 405 nm and a maximum power of 150 mW. After printing, the microlattices were released from the platform and washed gently with isopropyl alcohol (IPA) to remove any uncross-linked resin monomers (Form Wash, Formlabs, USA). Finally, the constructs were post-cured under UV light at room temperature for 30 mins (Form Cure, Formlabs, USA). The alginate solution was prepared with the dissolution of 1.5 g of the biopolymer powders in 100 ml deionized water to reach the final concentration of 1.5 wt % of the biopolymers. An oxygen plasma treatment was done on the 3D-printed microlattices prior to the injection of the biopolymer solution, to increase their hydrophilicity and wettability. A known volume (800 μL) of the alginate solution was injected into the 3D printed microlattice, followed by self-assembly of the polymer chains confined within the microlattice into hydrogels via Ca²⁺ ions through the chemical crosslinking process. The biopolymer-embedded microlattices were then freezed, freeze-dried and pyrolyzed at 1000° C. in a horizontal tubular ceramic furnace (OTF-1200X, MTI Corporation, USA) under a continuous nitrogen flow of 200 sccm throughout the process. Then, the electrodes were washed with 1M HCl solution under vacuum for 6 h to leach out CaO formed during the carbonization process, rinsed several times with water to adjust the electrode pH to neutral and finally dried at 40 C overnight.

### Coin Cell Assembly

The electrodes were transferred into a glove-box with an inert (Argon) atmosphere and dried inside a vacuum-dryer at 120 C for 12 h to remove any residual oxygen and humidity. The CR 2032-type coin cells were fabricated by using the 3D hybrid carbon materials as the working electrode and a lithium foil used as the reference and counter electrode. Borosilicate glass fibre (GF/D, Whatman) was used as a separator between two electrodes. The electrolyte used was 1M LiPF₆ in ethylene carbonate (EC)-ethyl methyl carbonate (EMC) (3:7 by weight, BASF LP-57). The coin cell batteries were tested under a constant current density of 100 mA g⁻¹ and a constant charge-discharge rate of C/10 (1C=300 mA g⁻¹) within a voltage window of 0.01-3 V versus Li/Lit. The specific capacities were calculated based on the weight of biomass-derived carbon aerogels inside the 3D microlattice electrodes.

### Results

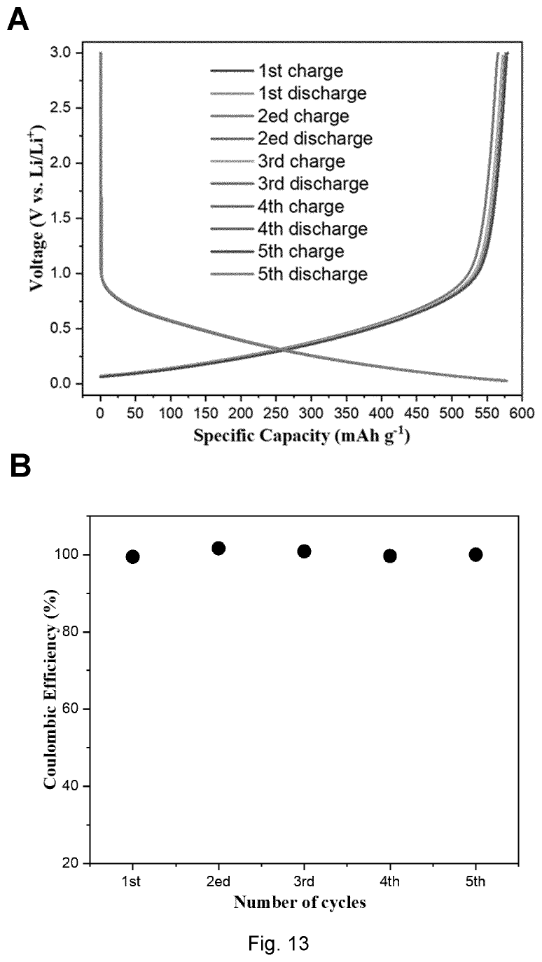

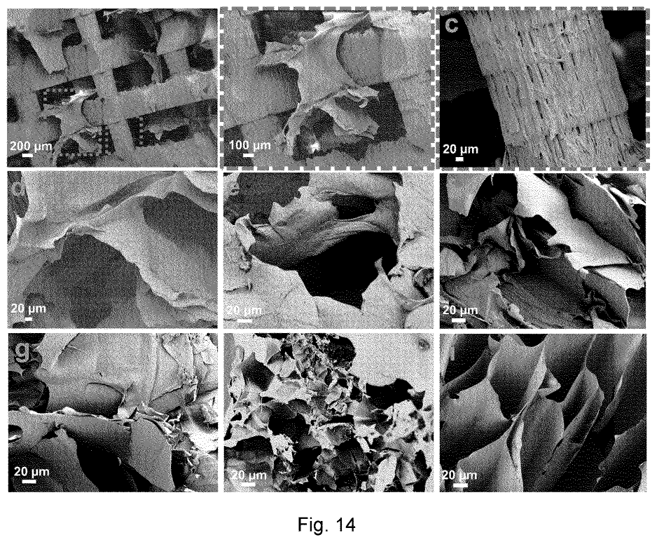

As can be seen in FIG. 13a, the cell showed a specific capacity of 570 mAh g⁻¹ at the current rate of C/10. Moreover, the coulombic efficiency (CE), which is equal to the ratio of the discharge capacity/charge capacity, remained almost constant (FIG. 13b) for the five consecutive tested cycles.

### Conclusion

These results confirm that the 3D hybrid carbon electrodes can be considered as promising alternative materials for developing free-standing, binder-free and metal current collector-free electrodes in ion batteries.

1. A method of producing a free-standing biomass-derived carbon hybrid electrode comprising:
a. providing an architectured polymeric template with a patterned three-dimensional open structure, wherein said architectured polymeric template has a designed macrostructural and/or microstructural architecture,
b. filling the template with a biomass-derived polymeric hydrogel,
c. converting the biomass-derived polymeric hydrogel into an aerogel, and
d. pyrolysing the aerogel-filled template to form a free-standing 3D carbon hybrid electrode.

2. The method according to claim 1, wherein said architectured polymeric template has a pattern defined by the placement of individual holes in the polymeric template, wherein the placement of said individual holes or empty spaces relative to each other is not arbitrary, and/or is not stochastic, and/or is controlled.

3. The method according to anyone of the preceding claims, wherein the architectured polymeric template with a patterned three-dimensional open structure is manufactured by means of additive manufacturing.

4. The method according to anyone of the preceding claims, wherein the step of providing the architectured polymeric template with a patterned three-dimensional open structure comprises 3D printing the polymeric template with a patterned three-dimensional open structure.

5. The method according to anyone of the preceding claims, wherein the step of providing the architectured polymeric template with a patterned three-dimensional open structure comprises 3D printing the polymeric template by means of stereolithography (SLA) 3D printing, Digital Light Processing (DLP), projection micro stereolithography (PuSLA), or Two-photon polymerization (2PP).

6. The method according to anyone of the preceding claims, wherein the architectured polymeric template has an open 3D microlattice pattern.

7. The method according to anyone of the preceding claims, wherein the architectured polymeric template comprises hollow parts.

8. The method according to anyone of the preceding claims, wherein the architectured polymeric template has a macroscopic open structure.

9. The method according to any one of the preceding claims, wherein the architectured polymeric template has a designed macroscopic pattern defined by the placement of individual holes have dimensions in the scale of tenths of milimiters (0.1 mm) to tens of centimeters (10 cm), wherein the placement of said individual holes relative to each other is not arbitrary, and/or is not stochastic, and/or is controlled.

10. The method according to anyone of the preceding claims, wherein the architectured polymeric template has a microscopic structure.

11. The method according to any one of the preceding claims, wherein the architectured polymeric template has a designed microscopic pattern defined by the placement of individual holes have dimensions in the scale of tenths of microns (0.1 μm) to tenths of milimiters (0.1 mm), wherein the placement of said individual holes relative to each other is not arbitrary, and/or is not stochastic, and/or is controlled.

12. The method according to anyone of the preceding claims, wherein the architectured polymeric template comprises a pyrolyzable photopolymer.

13. The method according to anyone of the preceding claims, wherein the photopolymer is a high-temperature resin.

14. The method according to anyone of the preceding claims, wherein the photopolymer polymerizes when exposed to actinic radiation.

15. The method according to anyone of the preceding claims, wherein the photopolymer comprises photopolymerizable groups such as vinyl, allyl, epoxy and/or styrenic groups.

16. The method according to anyone of the preceding claims, wherein the photopolymer comprises acrylate groups, methacrylate groups, epoxy groups or any combination thereof.

17. The method according to anyone of the preceding claims, wherein the photopolymer comprises acrylated monomers, epoxy-based monomers and/or methacrylated oligomers.

18. The method according to any one of the preceding claims, wherein the photopolymer comprises a photoinitiator.

19. The method according to anyone of the preceding claims, wherein the architectured polymeric template is a pyrolyzable material.

20. The method according to anyone of the preceding claims, wherein the architectured polymeric template is subjected to a pre-treatment prior to step b., wherein the pre-treatment increases the hydrophilicity of the architectured polymeric template.

21. The method according to anyone of the preceding claims, wherein the pre-treatment comprises surface coating, plasma treatment, glow discharge, silanization, macromolecule grafting and/or chemical processing of the architectured polymeric template.

22. The method according to anyone of the preceding claims, wherein the pre-treatment comprises oxygen or air plasma treatment of the architectured polymeric template.

23. The method according to anyone of the preceding claims, wherein step b. comprises filling the hollow parts of the architectured polymeric template with a homogeneous aqueous solution of a biomass-derived polymer.

24. The method according to anyone of the preceding claims, wherein step b. comprises cross-linking the biomass-derived polymer to form a hydrogel, thereby obtaining a hydrogel-filled architectured polymeric template.

25. The method according to anyone of the preceding claims, wherein step b. comprises cross-linking the biomass-derived polymer by gelation by physical cross-linking and/or by a chemical cross-linking to obtain the hydrogel.

26. The method according to anyone of the preceding claims, wherein the cross-linking is obtained by addition of a cross-linking agent.

27. The method according to anyone of the preceding claims, wherein cross-linking of the biomass-derived polymer to form a hydrogel comprises spraying the crosslinking agent and/or immersing the architectured polymeric template filled with the biomass-derived polymer in the crosslinking agent.

28. The method according to anyone of the preceding claims, wherein the architectured polymeric template filled with the biomass-derived polymer is immersed in the crosslinking agent for at least 5 minutes, such as for 5 to 60 minutes, such as for 5 to 30 minutes, such as for 5 to 20 minutes, such as for 5 to 15 minutes, such as for to 20 minutes, such as for about 15 minutes, such as for 12 hours, such as for overnight, such as for 24 hours.

29. The method according to anyone of the preceding claims, wherein the biomass-derived polymer is a polysaccharide-based polymer.

30. The method according to anyone of the preceding claims, wherein the biomass-derived polymer is agarose, cellulose, chitosan, gelzan, pectin, lignin or alginate.

31. The method according to any one of the preceding claims, wherein step b. comprises providing an inorganic compound.

32. The method according to any one of the preceding claims, wherein the inorganic compound is a water soluble salt of an ion selected from the group consisting of: calcium ion, permanganate ion, manganese ion, ruthenium ion, nickel ion, tin ion, iridium ion, iron ion, vanadium ion, cobalt ion, molybdenum ion, zinc ion and any combination thereof.

33. The method according to any one of the preceding claims, wherein step b. comprises precipitation of the inorganic compound in form of particles within the hydrogel-filled architectured polymeric template.

34. The method according to any one of the preceding claims, wherein the inorganic compound particles are calcium hydroxide particles.

35. The method according to any one of the preceding claims, wherein the inorganic compound particles are calcium carbonate particles.

36. The method according to anyone of the preceding claims, wherein the hydrogel-filled architectured polymeric template is washed with water prior to step c.

37. The method according to anyone of the preceding claims, wherein step c. comprises drying the hydrogel-filled architectured polymeric template to provide an aerogel-filled template.

38. The method according to any one of the preceding claims, wherein step c. comprises drying the hydrogel-filled architectured polymeric template using supercritical CO₂ drying, freeze drying, ambient drying, microwave drying or a combination thereof.

39. The method according to anyone of the preceding claims, wherein step c. comprises drying the hydrogel-filled architectured polymeric template using freeze-drying.

40. The method according to anyone of the preceding claims, wherein step d. comprises pyrolyzing the aerogel-filled architectured polymeric template under a inert atmosphere at 700° C. or more, such as at 750° C. or more, such as at 800° C. or more, such as at 850° C. or more, such at 900° C. or more, such as at 950° C. or more, such as at 1000° C. or more, such as at 1100° C., such as at between 900° C. and 1100° C., for at least 10 seconds, such as for at least 1 minute, such as for at least 10 minutes, such as for at least 30 minutes, such as for at least 60 minutes, such for at least 80 minutes, such as for at least 90 minutes, such as for at least 120 minutes, such as for at least 180 minutes, thereby obtaining a biomass-derived carbon electrode.

41. The method according to anyone of the preceding claims, wherein the pyrolysis occurs under nitrogen or argon atmosphere, or in vacuum.

42. The method according to anyone of the preceding claims, wherein the pyrolysis occurs in an oven, a heater, a griller and/or a furnace.

43. The method according to anyone of the preceding claims, wherein the pyrolyzing occurs in a tube furnace, such as a ceramic tube furnace, or a muffle furnace.

44. The method according to anyone of the preceding claims, wherein step d. comprises
a. heating the aerogel-filled architectured polymeric template under inert atmosphere at a temperature between 300° C. and 410° C. for at least 1 minute; and
b. heating the aerogel-filled architectured polymeric template under inert atmosphere at a temperature between 700° C. and 1100° C. for at least 1 minute.

45. The method according to anyone of the preceding claims, wherein step d. comprises
a. heating the aerogel-filled architectured polymeric template under an inert atmosphere at 350° C. to 500° C., such as at 400° C. to 450° C., for 30 minutes to 120 minutes, such as for about 1 hour; and
b. heating the aerogel-filled architectured polymeric template under a nitrogen atmosphere at 900° C. to 1100° C. for 30 minutes to 180 minutes, such as for about 2 hour.

46. The method according to anyone of the preceding claims, further comprising a step of post-activation of the pyrolyzed free-standing biomass-derived carbon electrode after step d.

47. The method according to any one of the preceding claims, wherein the post-activation is performed by treatment with KOH.

48. The method according to any one of the preceding claims, wherein the post-activation increases the surface area of the free-standing biomass-derived carbon electrode.

49. A free-standing hydrogel-filled architectured polymeric template, comprising an architectured polymeric template with a patterned three-dimensional open structure, wherein said architectured polymeric template has a designed macrostructural and/or microstructural architecture, and
a hydrogel comprising or consisting of a biomass-derived polymer.

50. The free-standing hydrogel-filled architectured polymeric template according to claim 49, wherein said template has a designed macrostructural and/or microstructural architecture, said architecture having a pattern defined by the placement of individual holes in the polymeric template, wherein the placement of said individual holes relative to each other is not arbitrary, and/or is not stochastic, and/or is controlled.

51. The free-standing hydrogel-filled architectured polymeric template according to any one of claims 49 to 50, wherein the hydrogel-filled architectured polymeric template comprises:
i. a hydrogel or an aerogel part; and
ii. an architectured polymeric template part, wherein said architectured polymeric part has a designed macrostructural and/or microstructural architecture said architecture having a pattern defined by the placement of individual holes in the polymeric template, wherein the placement of said individual holes relative to each other is not arbitrary, and/or is not stochastic, and/or is controlled.

52. The free-standing hydrogel-filled architectured polymeric template according to any one of claims 49 to 51, wherein said architectured polymeric template is as described in any one of claims 2 to 18.

53. Use of the free-standing hydrogel-filled architectured polymeric template according to any one of claims 49 to 52 as adsorbent for water and wastewater treatment.

54. A biomass-derived free-standing 3D carbon hybrid electrode comprising:
a pyrolyzed architectured polymeric template, wherein said architectured polymeric template has a designed macrostructural and/or microstructural architecture, and
a pyrolized biomass-derived polymeric aerogel,
wherein the pyrolyzed architectured polymeric template and the pyrolized biomass-derived polymeric aerogel are interconnected,
thereby forming a biomass-derived free-standing 3D carbon hybrid electrode comprising a pyrolized hydrogel-filled architectured polymeric template.

55. The biomass-derived free-standing 3D carbon hybrid electrode according to claim 54, wherein the pyrolyzed architectured polymeric template has a higher density than the pyrolyzed biomass-derived polymeric aerogel.

56. The biomass-derived free-standing 3D carbon hybrid electrode according to any one of claims 54 to 55, wherein said template has a designed macrostructural and/or microstructural architecture, said architecture having a pattern defined by the placement of individual holes in the polymeric template, wherein the placement of said individual holes relative to each other is not arbitrary, and/or is not stochastic, and/or is controlled.

57. The biomass-derived free-standing 3D carbon hybrid electrode according to any one of claims 54 to 56, wherein the pyrolyzed aerogel or the pyrolyzed hydrogel has an interconnected 3D hierarchical porous network structure consisting of macro-, meso- and micropores.

58. The biomass-derived free-standing 3D carbon hybrid electrode according to any one of claims 54 to 57, wherein the electrode is a monolithic structure, such as wherein the pyrolyzed aerogel-filled architectured polymeric template comprises carbon-carbon covalent bonds linking the pyrolzed architectured polymeric template and the pyrolyzed aerogel.

59. The biomass-derived free-standing 3D carbon hybrid electrode according to any one of claims claims 54 to 58, wherein wherein said architectured polymeric template is as described in any one of claims 2 to 18.

60. The biomass-derived free-standing 3D carbon hybrid electrode according to any one of claims 54 to 59, wherein the electrode has a thickness of 100 μm to 15 mm.

61. The biomass-derived free-standing 3D carbon hybrid electrode according to any one of claims 54 to 60, wherein the electrode has a total pore volume of 0.01 to 10 cm³/g.

62. The biomass-derived free-standing 3D carbon hybrid electrode according to any one of claims 54 to 61, wherein the electrode has a micropore volume of 0.01 to 3 cm³/g.

63. The biomass-derived free-standing 3D carbon hybrid electrode according to any one of claims 54 to 62, wherein the electrode has a micropore surface area of at least m²/g.

64. The biomass-derived free-standing 3D carbon hybrid electrode according to any one of claims 54 to 63, wherein the electrode comprises 3D interconnected frameworks of biomass-derived carbon aerogel.

65. The biomass-derived free-standing 3D carbon hybrid electrode according to any one of the claims 54 to 64, wherein the electrode has a Brunauer-Emmett-Teller (BET) specific surface area of at least 5 m²/g.

66. The biomass-derived free-standing 3D carbon hybrid electrode according to any one of claims 54 to 65, wherein the electrode has specific gravimetric capacitance of 5 to 3000 F/g of biomass weight.

67. The biomass-derived free-standing 3D carbon hybrid electrode according to any one of claims 54 to 66, wherein the electrode can function after being exposed to a crimping pressure of at least 50 bar.

68. The biomass-derived free-standing 3D carbon hybrid electrode according to any one of the claims 54 to 67, wherein the electrode does not comprise a binder material.

69. The biomass-derived free-standing 3D carbon hybrid electrode according to any one of claims 54 to 68, wherein the electrode is a binder-free electrode.

70. The biomass-derived free-standing 3D carbon hybrid electrode according to any one of claims 54 to 69, wherein the electrode does not comprise an additional metallic current collector.

71. A battery comprising a biomass-derived free-standing 3D carbon hybrid electrode according to any one of the preceding claims.

72. A supercapacitor comprising a biomass-derived free-standing 3D carbon hybrid electrode according to any one of the preceding claims.

73. A fuel cell comprising a biomass-derived free-standing 3D carbon hybrid electrode according to any one of the preceding claims.

74. The battery according to claim 71, the supercapacitor according to claim 72 or the fuel cell according to claim 73, wherein said electrode does not comprise a binder and/or a metallic current collector.

75. Use of a biomass-derived free-standing 3D carbon hybrid electrode according to any one of the preceding claims for energy storage, energy conversion, electrocatalysis, water and wastewater treatment, and/or CO₂ capture.
